(19) United States
(12) Patent Application Publication
(10) Pub. No.: US 2012/0229678 A1
(43) Pub. Date: Sep. 13, 2012

(54) IMAGE REPRODUCING CONTROL APPARATUS

(75) Inventor: Masayoshi Okamoto, Daito-shi (JP)

(73) Assignee: SANYO ELECTRIC CO., LTD., Osaka (JP)

(21) Appl. No.: 13/397,840

(22) Filed: Feb. 16, 2012

(30) Foreign Application Priority Data
Mar. 10, 2011 (JP) 2011-053398

(51) Int. Cl. H04N 5/262

(52) U.S. Cl. 348/239; 348/E05.031

(57) ABSTRACT

An image reproducing control apparatus includes an acquirer. An acquirer acquires a plurality of images including one or at least two images respectively focused on one or at least two objects, corresponding to a common viewing field. A reproducer reproduces any one of the plurality of images acquired by the acquirer. An acceptor accepts a designating operation of designating any one of one or at least two objects appeared in the image reproduced by the reproducer. A searcher searches for an image focused on the object designated by the designating operation from among the plurality of images acquired by the acquirer. An updater updates an image to be reproduced by the reproducer to an image different depending on a searched result of the searcher.

### CROSS REFERENCE OF RELATED APPLICATION

The disclosure of Japanese Patent Application No. 2011-53398, which was filed on Mar. 10, 2011, is incorporated here by reference.

### BACKGROUND OF THE INVENTION

1. Field of the Invention

The present invention relates to an image reproducing control apparatus. More particularly, the present invention relates to an image reproducing control apparatus which is applied to an electronic camera and acquires one or at least two images respectively focused on one or at least two objects, corresponding to a common viewing field.

2. Description of the Related Art

According to one example of this type of apparatus, when a photographing instruction is accepted by an operating portion, a focus position of a photographing optical system is changed, and a plurality of recording image data having different focus positions is acquired from a CMOS sensor portion. A storer stores the plurality of recording image data, face region information of each of the recording image data and focus degree information as a single multi page file, and further stores recording image data having the highest focus degree information as another file. Thereby, it becomes possible to certainly acquire an image in focus on a person whom a photographer desires.

However, in the above-described apparatus, the image in focus on the person whom the photographer desires is not preferentially reproduced, and therefore, an operability of an image reproducing is limited.

### SUMMARY OF THE INVENTION

An image reproducing control apparatus according to the present invention, comprises: an acquirer which acquires a plurality of images including one or at least two images respectively focused on one or at least two objects, corresponding to a common viewing field; a reproducer which reproduces any one of the plurality of images acquired by the acquirer; an acceptor which accepts a designating operation of designating any one of one or at least two objects appeared in the image reproduced by the reproducer; a searcher which searches for an image focused on the object designated by the designating operation from among the plurality of images acquired by the acquirer; and an updater which updates an image to be reproduced by the reproducer to an image different depending on a searched result of the searcher.

According to the present invention, an image reproducing control program recorded on a non-transitory recording medium when executed by a processor of an image reproducing control apparatus, the program causing the image reproducing control apparatus to perform the steps comprises: an acquiring step of acquiring a plurality of images including one or at least two images respectively focused on one or at least two objects, corresponding to a common viewing field; a reproducing step of reproducing any one of the plurality of images acquired by the acquiring step; an accepting step of accepting a designating operation of designating any one of one or at least two objects appeared in the image reproduced by the reproducing step; a searching step of searching for an image focused on the object designated by the designating operation from among the plurality of images acquired by the acquiring step; and an updating step of updating an image to be reproduced by the reproducing step to an image different depending on a searched result of the searching step.

According to the present invention, an image reproducing control method executed by an image reproducing control apparatus, comprises: an acquiring step of acquiring a plurality of images including one or at least two images respectively focused on one or at least two objects, corresponding to a common viewing field; a reproducing step of reproducing any one of the plurality of images acquired by the acquiring step; an accepting step of accepting a designating operation of designating any one of one or at least two objects appeared in the image reproduced by the reproducing step; a searching step of searching for an image focused on the object designated by the designating operation from among the plurality of images acquired by the acquiring step; and an updating step of updating an image to be reproduced by the reproducing step to an image different depending on a searched result of the searching step.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of an allocation state of an evaluation area in an imaging surface;

FIG. 4 is an illustrative view showing one example of a face frame structure used for a face detecting process;

FIG. 5 is an illustrative view showing one example of a configuration of a face dictionary referred to in the face detecting process;

FIG. 6 is an illustrative view showing one portion of the face detecting process;

FIG. 7 is an illustrative view showing one example of a configuration of a register used for the face detecting process;

FIG. 8 is an illustrative view showing one example of a live view image displayed on an LCD monitor under a face-continuous-shooting mode;

FIG. 9 is an illustrative view showing one example of a structure of a face-continuous-shooting group file created under the face-continuous-shooting mode;

FIG. 10 is an illustrative view showing one example of a configuration of a simple AF distance table created in a block-continuous-shooting and recording process;

FIG. 11 is an illustrative view showing one example of a positional relationship between a camera and an object;

FIG. 12 is an illustrative view showing one portion of the block-continuous-shooting and recording process;

FIG. 13(A) is an illustrative view showing one portion of a fine adjustment range set in the block-continuous-shooting and recording process;

FIG. 13(B) is an illustrative view showing another portion of the fine adjustment range set in the block-continuous-shooting and recording process;

FIG. 13(C) is an illustrative view showing still another portion of the fine adjustment range set in the block-continuous-shooting and recording process;

FIG. 14 is an illustrative view showing one example of a configuration of an integrated fine adjustment range table created in the block-continuous-shooting and recording process;

FIG. 15 is an illustrative view showing another portion of the block-continuous-shooting and recording process;

FIG. 16 is an illustrative view showing one example of a configuration of a strict AF distance table created in the block-continuous-shooting and recording process;

FIG. 17 is an illustrative view showing one example of a structure of a block-continuous-shooting group file created under a block-continuous-shooting mode;

FIG. 18(A) is an illustrative view showing one example of an image reproduced from the face-continuous-shooting group file under a group file reproducing mode;

FIG. 18(B) is an illustrative view showing another example of the image reproduced from the face-continuous-shooting group file under the group file reproducing mode;

FIG. 19(A) is an illustrative view showing still another example of the image reproduced from the face-continuous-shooting group file under the group file reproducing mode;

FIG. 19(B) is an illustrative view showing yet another example of the image reproduced from the face-continuous-shooting group file under the group file reproducing mode;

FIG. 20(A) is an illustrative view showing one example of an image reproduced from the block-continuous-shooting group file under the group file reproducing mode;

FIG. 20(B) is an illustrative view showing another example of the image reproduced from the block-continuous-shooting group file under the group file reproducing mode;

FIG. 21(A) is an illustrative view showing still another example of the image reproduced from the block-continuous-shooting group file under the group file reproducing mode;

FIG. 21(B) is an illustrative view showing yet another example of the image reproduced from the block-continuous-shooting group file under the group file reproducing mode;

FIG. 22 is a flowchart showing one portion of behavior of a CPU applied to the embodiment in FIG. 2;

FIG. 23 is a flowchart showing another portion of behavior of the CPU applied to the embodiment in FIG. 2;

FIG. 24 is a flowchart showing still another portion of behavior of the CPU applied to the embodiment in FIG. 2;

FIG. 25 is a flowchart showing yet another portion of behavior of the CPU applied to the embodiment in FIG. 2;

FIG. 26 is a flowchart showing another portion of behavior of the CPU applied to the embodiment in FIG. 2;

FIG. 27 is a flowchart showing still another portion of behavior of the CPU applied to the embodiment in FIG. 2;

FIG. 28 is a flowchart showing yet another portion of behavior of the CPU applied to the embodiment in FIG. 2;

FIG. 29 is a flowchart showing another portion of behavior of the CPU applied to the embodiment in FIG. 2;

FIG. 30 is a flowchart showing still another portion of behavior of the CPU applied to the embodiment in FIG. 2;

FIG. 31 is a flowchart showing yet another portion of behavior of the CPU applied to the embodiment in FIG. 2;

FIG. 32 is a flowchart showing another portion of behavior of the CPU applied to the embodiment in FIG. 2;

FIG. 33 is a flowchart showing still another portion of behavior of the CPU applied to the embodiment in FIG. 2;

FIG. 34 is a flowchart showing yet another portion of behavior of the CPU applied to the embodiment in FIG. 2;

FIG. 35 is a flowchart showing another portion of behavior of the CPU applied to the embodiment in FIG. 2; and

FIG. 36 is a block diagram showing a configuration of another embodiment of the present invention.

### DETAILED DESCRIPTION OF THE PREFERRED EMBODIMENTS

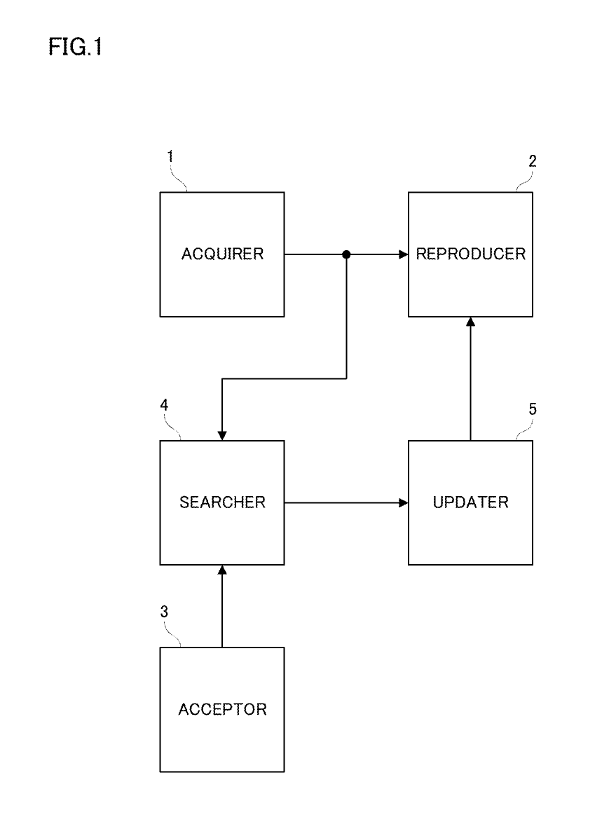

With reference to FIG. 1, an image reproducing control apparatus according to one embodiment of the present invention is basically configured as follows: An acquirer 1 acquires a plurality of images including one or at least two images respectively focused on one or at least two objects, corresponding to a common viewing field. A reproducer 2 reproduces any one of the plurality of images acquired by the acquirer 1. An acceptor 3 accepts a designating operation of designating any one of one or at least two objects appeared in the image reproduced by the reproducer 2. A searcher 4 searches for an image focused on the object designated by the designating operation from among the plurality of images acquired by the acquirer 1. An updater 5 updates an image to be reproduced by the reproducer 2 to an image different depending on a searched result of the searcher 4.

When an operation of designating any one of the one or at least two objects appeared in the reproduced image is accepted, the image focused on the designated object is searched from among the plurality of images. The reproduced image and the plurality of images to be a searching target have a mutually common viewing field, and the reproduced image is updated to the image different depending on a result of a searching process. Thereby, an operability of an image reproducing is improved.

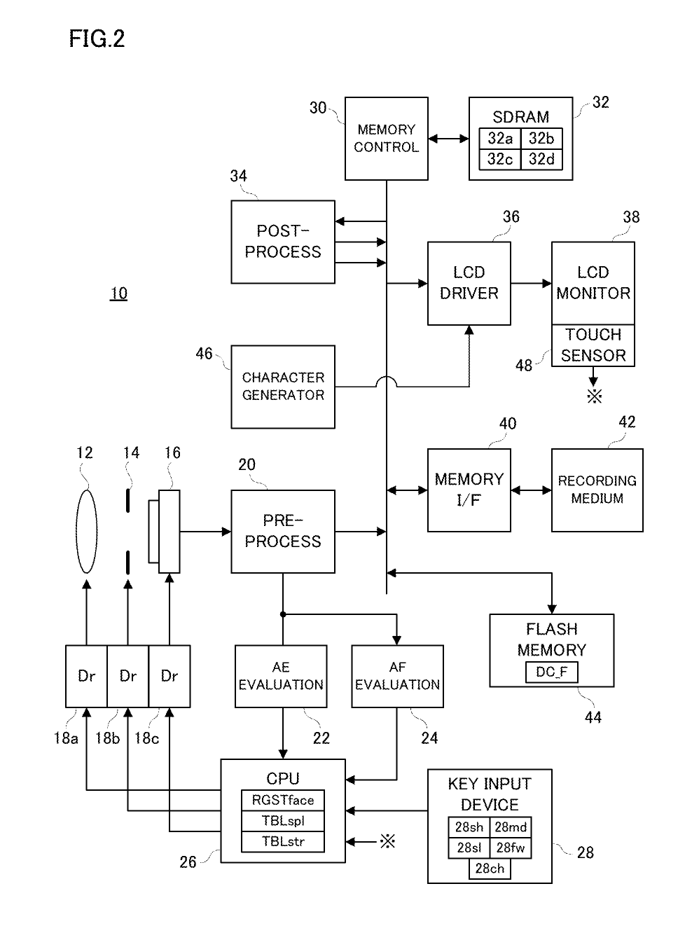

With reference to FIG. 2, a digital camera 10 according to one embodiment includes a focus lens 12 and an aperture unit 14 driven by drivers 18a and 18b, respectively. An optical image of a scene that underwent these components enters, with irradiation, an imaging surface of an imager 16, and is subjected to a photoelectric conversion. Thereby, electric charges representing a scene image are produced.

When an imaging mode is selected by a mode selector switch 28md, in order to enable a pan-focus setting under an imaging task, a CPU 26 applies a corresponding command to the drivers 18a and 18b. Thereby, a position of the focus lens 12 and an aperture amount of the aperture unit 14 are adjusted so that a depth of field becomes deep.

Subsequently, in order to start a moving-image taking process, the CPU 26 commands a driver 18c to repeat an exposure procedure and an electric-charge reading-out procedure. In response to a vertical synchronization signal Vsync periodically generated from an SG (Signal Generator) not shown, the driver 18c exposes the imaging surface and reads out the electric charges produced on the imaging surface in a raster scanning manner. From the imager 16, raw image data that is based on the read-out electric charges is cyclically outputted.

A pre-processing circuit 20 performs processes, such as digital clamp, pixel defect correction, gain control and etc., on the raw image data outputted from the imager 16. The raw image data on which these processes are performed is written into a raw image area 32a of an SDRAM 32 through a memory control circuit 30.

A post-processing circuit 34 reads out the raw image data accommodated in the raw image area 32a through the memory control circuit 30, and performs a color separation process, a white balance adjusting process and a YUV converting process, on the read-out raw image data. Furthermore, the post-processing circuit 34 executes a zoom process for display and a zoom process for exploring to image data that comply with a YUV format, in a parallel manner. As a result, display image data and exploration image data that comply with the YUV format are individually created.

The display image data is written into a display image area 32b of the SDRAM 32 by the memory control circuit 30. Moreover, the exploration image data is written into an exploration image area 32c of the SDRAM 32 by the memory control circuit 30.

An LCD driver 36 repeatedly reads out the display image data accommodated in the display image area 32b through the memory control circuit 30, and drives an LCD monitor 38 based on the read-out image data. As a result, a real-time moving image (a live view image) of the scene is displayed on a monitor screen.

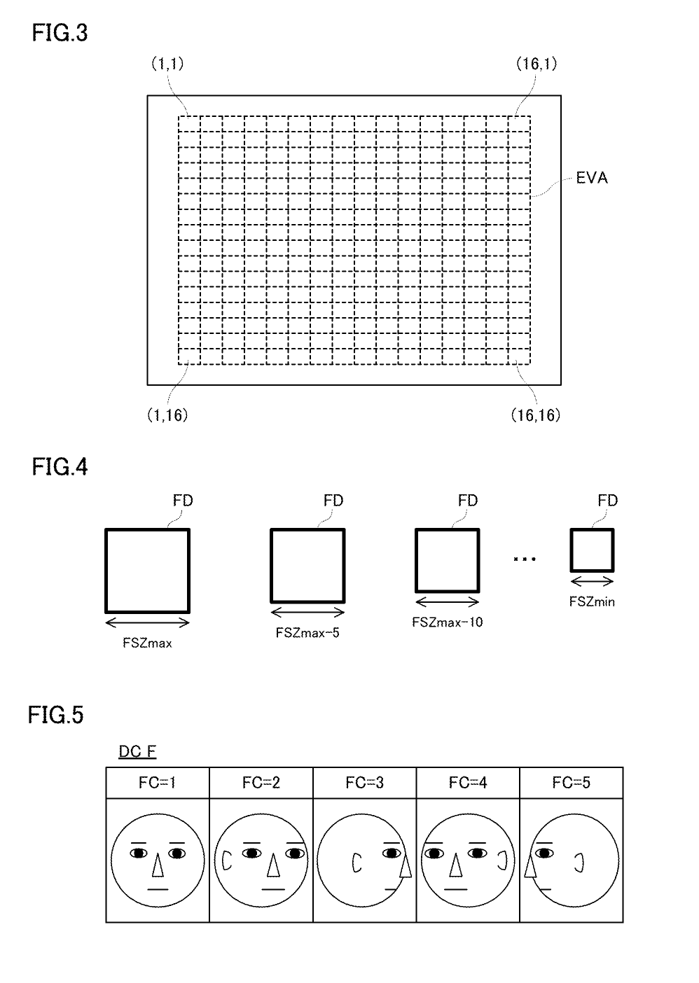

With reference to FIG. 3, the evaluation area EVA is divided into 16 portions in each of a horizontal direction and a vertical direction; therefore, an evaluation area EVA is formed by 256 divided blocks. Moreover, in addition to the above-described processes, the pre-processing circuit 20 shown in FIG. 2 executes a simple RGB converting process which simply converts the raw image data into RGB data.

An AE evaluating circuit 22 integrates RGB data belonging to the evaluation area EVA, out of the RGB data produced by the pre-processing circuit 20, for each divided block. The integrating process is executed at every time the vertical synchronization signal Vsync is generated. Thereby, 256 integral values (256 AE evaluation values) are outputted from the AE evaluating circuit 22 in response to the vertical synchronization signal Vsync.

Moreover, an AF evaluating circuit 24 integrates a high-frequency component of the RGB data belonging to the evaluation area EVA, out of the RGB data generated by the pre-processing circuit 20, for each divided block. The integrating process is also executed at every time the vertical synchronization signal Vsync is generated. Thereby, 256 integral values (256 AF evaluation values) are outputted from the AF evaluating circuit 24 in response to the vertical synchronization signal Vsync.

An AE process based on the AE evaluation values outputted from the AE evaluating circuit 22 and an AF process based on the AF evaluation values outputted from the AF evaluating circuit 24 will be described later.

Moreover, the CPU 26 executes a face detecting task in parallel with the imaging task. Under the face detecting task, a face image of a person is repeatedly explored from the exploration image data accommodated in the exploration image area 32c. At this time, a face-detection frame structure FD of which size is adjusted as shown in FIG. 4 and a face dictionary DC_F containing five dictionary images shown in FIG. 5 are used.

The face dictionary DC_F is stored in a flash memory 44. Moreover, in the face dictionary DC_F, a dictionary image assigned to FC=1 is equivalent to a face image oriented to a front, a dictionary image assigned to FC=2 is equivalent to a face image oriented diagonally forward left, and a dictionary image assigned to FC=3 is equivalent to a face image oriented to a left. Furthermore, a dictionary image assigned to FC=4 is equivalent to a face image oriented diagonally forward right, and a dictionary image assigned to FC=5 is equivalent to a face image oriented to a right.

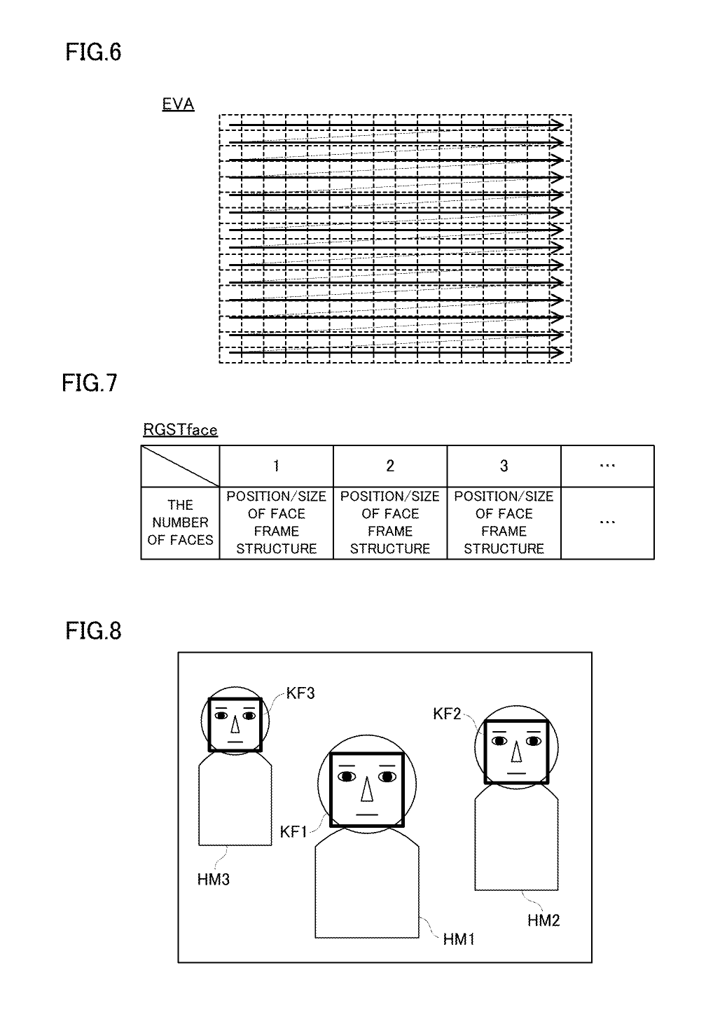

In the face detecting task, firstly, the whole evaluation area EVA is set as a face exploring area. Moreover, in order to define a variable range of the size of the face frame structure FD, a maximum size FSZmax is set to “200”, and a minimum size FSZmin is set to “20”. At every time the vertical synchronization signal Vsync is generated, the face frame structure FD is moved by each predetermined amount in the raster scanning manner, from a start position (an upper left position) toward an ending position (a lower right position) which are allocated on the face exploring area (see FIG. 6). Moreover, the size of the face frame structure FD is reduced by a scale of “5” from “FSZmax” to “FSZmin” at every time the face frame structure FD reaches the ending position.

Partial exploration image data belonging to the face frame structure FD is read out from the exploration image area 32c through the memory control circuit 30. A characteristic amount of the read-out exploration image data is compared with a characteristic amount of each of the five dictionary images contained in the face dictionary DC_F. When a matching degree which is a compared result is equal to or more than THface, it is regarded that the face image has been detected. A position and a size of the face frame structure FD at a current time point are registered as face information in a register RGSTface shown in FIG. 7. Moreover, the number of the face frame structures described in the register RGSTface is incremented along with the registering process.

When the number of the face frame structures described in the register RGSTface is equal to or more than “1” at a time point at which a face frame structure FD having a minimum size FSZmin has reached the ending position of the face exploring area, the CPU 26 applies a face-frame-structure character display command to a character generator 46. The character generator 46 applies corresponding character data to the LCD driver 36, and the LCD driver 36 drives the LCD monitor 38 based on the applied character data. As a result, a face frame structure character surrounding the detected face image is displayed on the LCD monitor 38 in an OSD manner.

Thus, when persons HM1 to HM3 are captured as shown in FIG. 8, a face frame structure character KF1 is displayed in a manner to surround a face image of the person HM1, a face frame structure character KF2 is displayed in a manner to surround a face image of the person HM2, and a face frame structure character KF3 is displayed in a manner to surround a face image of the person HM3.

In contrary, when the number of the face frame structures described in the register RGSTface is “0” at a time point at which the face frame structure FD having the minimum size FSZmin has reached the ending position of the face exploring area, the CPU 26 applies a face-frame-structure hiding command to the character generator 46. The character generator 46 stops to output the character data, and as a result, the face frame structure character is hidden.

When a shutter button 28sh is in a non-operated state, under the imaging task, the CPU 26 repeatedly executes a simple AE process that is based on partial AE evaluation values outputted from the AE evaluating circuit 22 corresponding to a center of the evaluation are EVA. In the simple AE process, an appropriate EV value is calculated, and an aperture amount and an exposure time period that define the calculated appropriate EV value are set to the drivers 18b and 18c, respectively. Thereby, a brightness of a live view image is adjusted approximately.

When the shutter button 28sh is operated, the CPU 26 executes a strict AE process in a manner different depending on a face-detection result. When a face image is detected by the face detecting task, the strict AE process is executed with reference to partial AE evaluation values outputted from the AE evaluating circuit 22 corresponding to the detected face image. In contrary, when the face image is not detected by the face detecting task, the strict AE process is executed with reference to partial AE evaluation values outputted from the AE evaluating circuit 22 corresponding to the center of the evaluation are EVA. An aperture amount and an exposure time period that define the optimal EV value calculated by the strict AE process are set to the drivers 18b and 18c, respectively. As a result, a brightness of a live view image is adjusted to an optimal value.

The imaging mode is set to any one of a normal mode, a face-continuous-shooting mode and a block-continuous-shooting mode by a mode selecting button 28sl.

If the imaging mode at a current time point is the normal mode, or if the number of face images detected by the face detecting task (=the number of the face frame structures described in the register RGSTface) is “0” despite that the imaging mode at a current time point is the face-continuous-shooting mode, the CPU 26 executes a normal recording process. Moreover, when the imaging mode at a current time point is the face-continuous-shooting mode and the number of the face images detected by the face detecting task is equal to or more than “1”, the CPU 26 executes a face-continuous-shooting and recording process. Furthermore, when the imaging mode at a current time point is the block-continuous-shooting mode, the CPU 26 executes a block-continuous-shooting and recording process.

In the normal recording process, firstly, the AF process is executed in a manner different depending on the face-detection result. When a face image is detected by the face detecting task, the AF process is executed with reference to partial AF evaluation values outputted from the AF evaluating circuit 24 corresponding to the detected face image. In contrary, when the face image is not detected by the face detecting task, the AF process is executed with reference to partial AF evaluation values outputted from the AF evaluating circuit 24 corresponding to the center of the evaluation are EVA. The focus lens 12 is placed at a position at which a total sum of the referred AF evaluation values reaches a maximum, and thereby, a sharpness of a live view image is improved.

Upon completion of the AF process, the CPU 26 executes a still-image taking process and requests a memory I/F 40 to execute a recording process. One frame of image data representing a scene at a time point at which the AF process is completed is evacuated by the still-image taking process from the YUV image area 32b to a still-image area 32d. The evacuated image data is read out by the memory I/F 40 and is recorded on a recording medium 42 in a file format.

In the face-continuous-shooting and recording process, firstly, the CPU 26 requests the memory I/F 40 to create a face-continuous-shooting group file. As a result, the face-continuous-shooting group file is created in the recording medium 42 by the memory I/F 40. Subsequently, the CPU 26 executes the still-image taking process and requests the memory I/F 40 to execute the recording process. The latest one frame of the image data is corresponding to the pan-focus setting, and is evacuated by the still-image taking process from the YUV image area 32b to the still-image area 32d. The memory I/F 40 reads out, through the memory control circuit 30, the image data thus evacuated so as to write the read-out image data into the face-continuous-shooting group file.

Subsequently, a variable K is set to each of “1” to “Kmax” (Kmax: the number of the face frame structures described in the register RGSTface), and an AF process for Kth face is executed. A focal point is searched with reference to partial AF evaluation values outputted from the AF evaluating circuit 24 corresponding to a K-th face frame structure registered in the register RGSTface, and the focus lens 12 is placed at the focal point discovered thereby.

Subsequently, the CPU 26 executes the still-image taking process and requests the memory I/F 40 to execute the recording process. One frame of image data representing a scene at a time point at which the AF process for Kth face is completed is evacuated by the still-image taking process from the YUV image area 32b to the still-image area 32d. The memory I/F 40 reads out, through the memory control circuit 30, the image data thus evacuated and writes the read-out image data into the face-continuous-shooting group file.

Thereafter, the CPU 26 requests the memory I/F 40 to update a file header. The memory I/F 40 describes a position and a size of the K-th face frame structure registered in the register RGSTface in a header of the face-continuous-shooting group file, corresponding to a frame number (=K) of the latest image data written in the face-continuous-shooting group file.

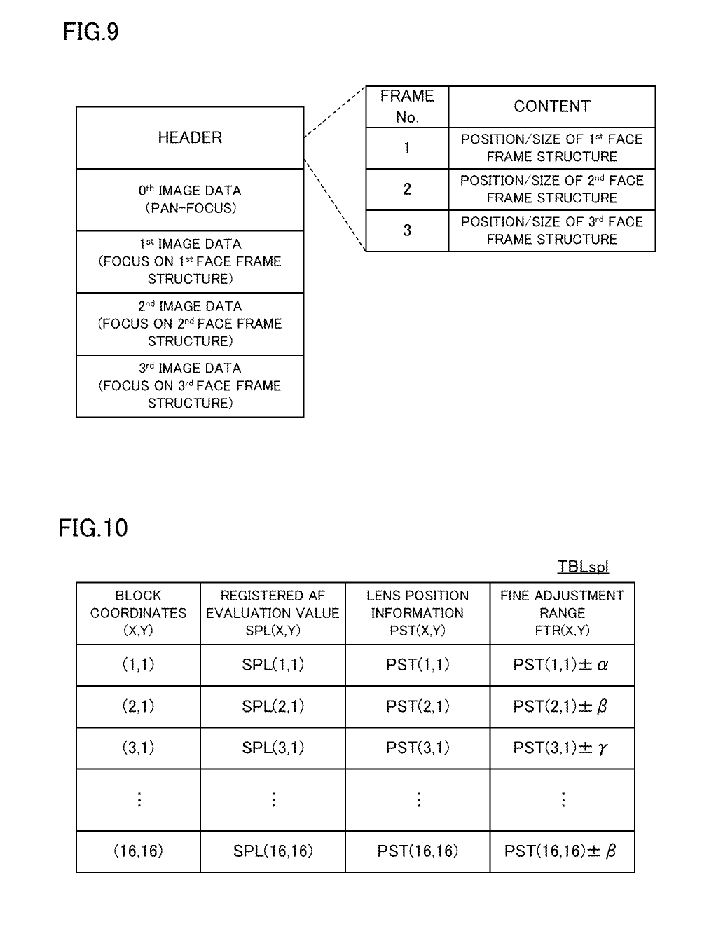

The face-continuous-shooting group file has a structure shown in FIG. 9 at a time point at which a header describing process for number of times equivalent to the number of the face frame structures described in the register RGSTface is completed.

In the block-continuous-shooting and recording process, firstly, the CPU 26 requests the memory I/F 40 to create a block-continuous-shooting group file. As a result, the block-continuous-shooting group file is created in the recording medium 42 by the memory I/F 40. Subsequently, the CPU 26 executes the still-image taking process and requests the memory I/F 40 to execute the recording process. The latest one frame of the image data is corresponding to the pan-focus setting, and is evacuated by the still-image taking process from the YUV image area 32b to the still-image area 32d. The memory I/F 40 reads out, through the memory control circuit 30, the image data thus evacuated and writes the read-out image data into the block-continuous-shooting group file.

Subsequently, descriptions of a simple AF distance table TBLspl shown in FIG. 10 are cleared, and the focus lens 12 is placed at an infinite end. As a result of a table clearing process, any of registered AF evaluation values SPL (1, 1) to SPL (16, 16) described in the simple AF distance table TBLspl indicates “0”, and any of lens position information PST (1, 1) to PST (16, 16) described in the simple AF distance table TBLspl indicates “indeterminate”.

It is noted that strictly speaking, block coordinates (1, 1) to (16, 16) are assigned to the 256 divided blocks forming the evaluation area EVA shown in FIG. 3. Here, a numerical value of a left side in parentheses is equivalent to a coordinate in an X direction (=horizontal direction), and a numerical value of a right side in the parentheses is equivalent to a coordinate in a Y direction (=vertical direction). In an explanation of the block-continuous-shooting and recording process, an AF evaluation value detected corresponding to block coordinates (X, Y) are especially defined as “Iyh (X, Y).

When the vertical synchronization signal Vsync is generated, 256 AF evaluation values Iyh (1, 1) to Iyh (16, 16) outputted from the AF evaluating circuit 24 are taken by the CPU 26. Moreover, variables X and Y are set to each of “1” to “16” to designate the 256 divided blocks in order.

When an AF evaluation value Iyh (X, Y) exceeds a registered AF evaluation value SPL (X, Y), the AF evaluation value Iyh (X, Y) is described in the simple AF distance table TBLspl as the registered AF evaluation value SPL (X, Y). Furthermore, a position of the focus lens 12 at a current time point is described in the simple AF distance table TBLspl as lens position information PST (X, Y).

The focus lens 12 is moved by a predetermined amount from the infinite end to a nearest end in parallel with the processes. The lens position information PST (X, Y) indicates a focal point at the block coordinates (X, Y), and the registered AF evaluation value SPL (X, Y) indicates a maximum AF evaluation value at the block coordinates (X, Y), at a time point at which the focus lens 12 has reached the nearest end. Thus, 256 focal points respectively corresponding to the 256 divided blocks are simply detected.

Subsequently, each of the variables X and Y is set to “1” to “16” in order, to designate the 256 divided blocks again, and a fine adjustment range FTR (X, Y) is defined based on the registered AF evaluation value SPL (X, Y) and the lens position information PST (X, Y). The defined fine adjustment range FTR (X, Y) has expansion enlarged corresponding to an increase of the registered AF evaluation value SPL (X, Y), by using a position defined by the lens position information PST (X, Y) as the center. The fine adjustment range FTR (X, Y) is registered in the simple AF distance table TBLspl as shown in FIG. 10.

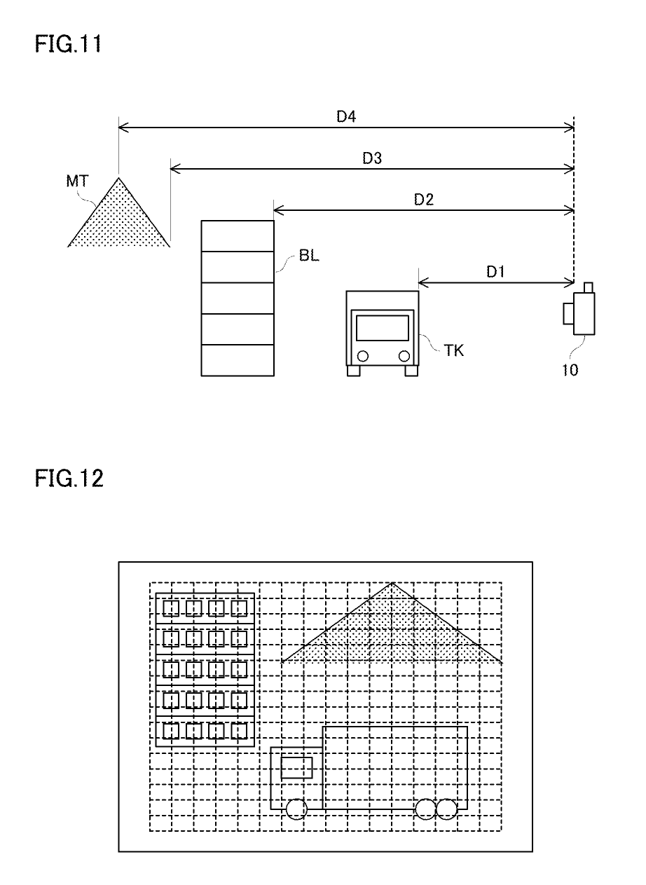

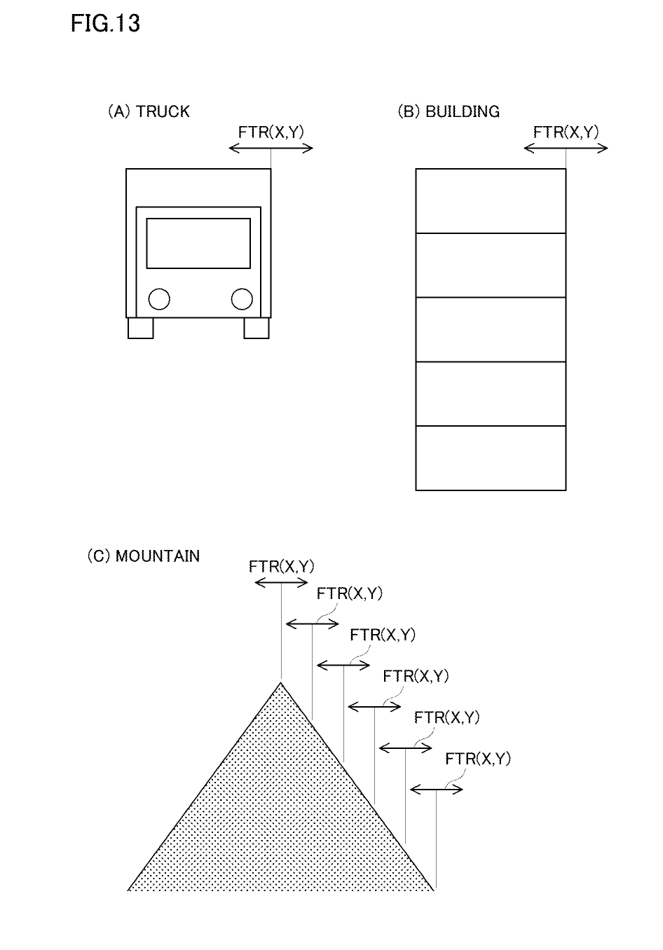

Thus, when a truck TK existing at a distance D1, a building BLD existing at a distance D2 and a mountain MT existing at distances D3 to D4 are captured as shown in FIG. 11 to FIG. 12, the fine adjustment range FTR (X, Y) is defined as shown in FIG. 13(A), FIG. 13(B) and FIG. 13(C) respectively corresponding to a divided block on an image representing the truck TK, a divided block on an image representing the building BL and a divided block on an image representing the mountain MT.

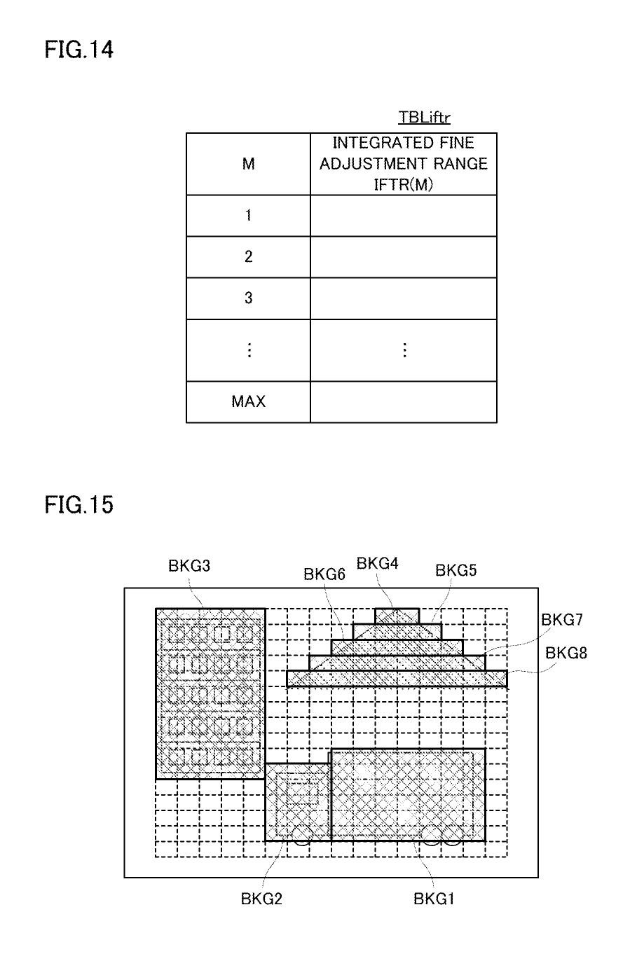

When all of fine adjustment ranges FTR (1, 1) to (16, 16) are defined, overlaps between the fine adjustment ranges FTR (1, 1) to FTR (16, 16) are detected, and a plurality of the fine adjustment ranges in which an overlapping degree exceeds 90% is integrated. As a result, MAX (MAX: an integer equal to or less than 256) of integrated fine adjustment ranges IFTR (1) to IFTR (MAX) are redefined. The redefined integrated fine adjustment ranges IFTR (1) to IFTR (MAX) are described in an integrated fine adjustment range table TBLiftr shown in FIG. 14.

Thus, in an above-described example, as shown in FIG. 15, a certain integrated fine adjustment range is defined corresponding to a divided block group BKG 1 covering an image representing a back of the truck TK, and another integrated fine adjustment range is defined corresponding to a divided block group BKG 2 covering an image representing a driver's seat of the truck TK. Moreover, still another integrated fine adjustment range is defined corresponding to a divided block group BKG 3 covering an image representing the building BL. Furthermore, the other five integrated fine adjustment ranges are defined corresponding to divided block groups BKG 4 to BKG 8 dispersively covering an image representing the mountain MT from a summit to a foot.

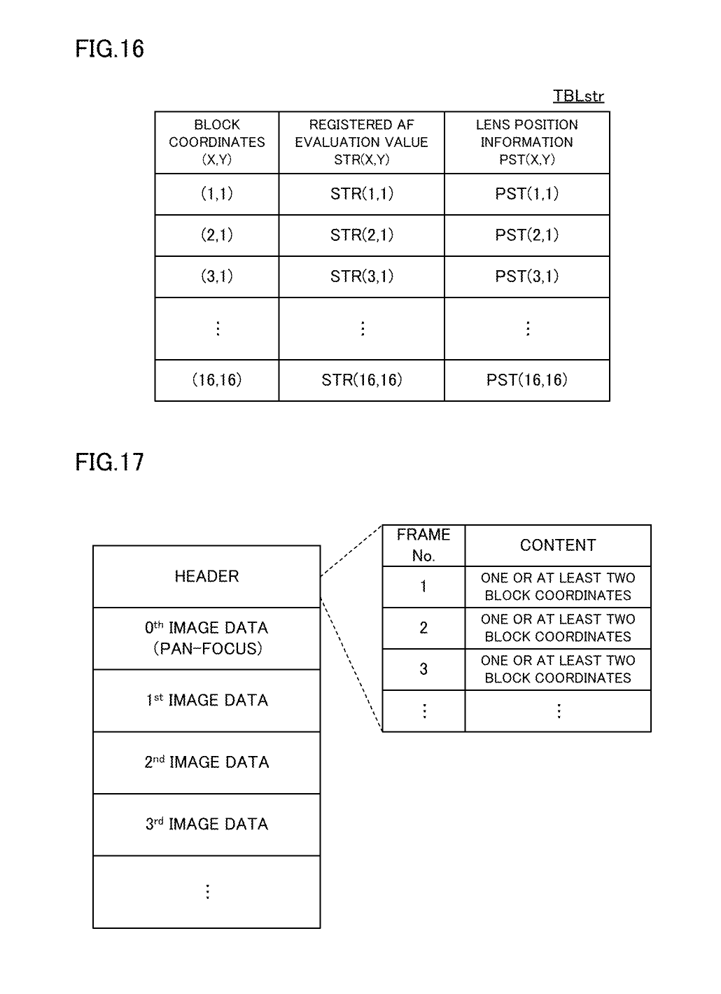

Subsequently, a strict AF distance table TBLstr shown in FIG. 16 is cleared. Any of registered AF evaluation values STR (1, 1) to STR (16, 16) described in the strict AF distance table TBLstr is set to “0”, and any of lens position information PST (1, 1) to PST (16, 16) described in the strict AF distance table TBLstr is set to “indeterminate”.

A variable M is set to each of “1” to “MAX”, and the focus lens 12 is moved by a predetermined amount from an infinite end to a nearest end of the integrated fine adjustment range IFTR (M) described in the integrated fine adjustment range table TBLiftr. That is, a process of moving the focus lens 12 from the infinite end to the nearest end is executed for number of times equivalent to “MAX”, corresponding to the integrated fine adjustment ranges IFTR (1) to IFTR (MAX).

The AF evaluation values Iyh (1, 1) to Iyh (16, 16) outputted from the AF evaluating circuit 24 are taken by the CPU 26 at every time the vertical synchronization signal Vsync is generated. Moreover, the variables X and Y are set to each of “1” to “16” to designate the 256 divided blocks in order.

When a position of the focus lens 12 at a current time point belongs to the fine adjustment range FTR (X, Y) and the AF evaluation value Iyh (X, Y) exceeds a registered AF evaluation value STR (X, Y), the AF evaluation value Iyh (X, Y) is registered in the strict AF distance table TBLstr as the registered AF evaluation value STR (X, Y), and the position of the focus lens 12 at the current time point is registered in the strict AF distance table TBLstr as the lens position information PST (X, Y).

Accordingly, the lens position information PST (X, Y) indicates a focal point at the block coordinates (X, Y), and the registered AF evaluation value STR (X, Y) indicates a maximum AF evaluation value at the block coordinates (X, Y), at a time point at which the focus lens 12 has reached the nearest end of the integrated fine adjustment range IFTR (MAX). Thus, 256 focal points respectively corresponding to the 256 divided blocks are strictly detected.

The lens position information PST (X, Y) described in the strict AF distance table TBLstr is sorted in order from infinity. That is, 256 lens positions indicating the focal points are relocated on the strict AF distance table TBLstr so as to line up in order from the infinity.

The variable K is sequentially set to each of “1” to “256”, and lens position information indicating the K-th lens position from the infinity is detected from the sorted strict AF distance table TBLstr. When a lens position indicated by the detected lens position information is different from a current position of the focus lens 12, the focus lens 12 is placed at the lens position indicated by the detected lens position information.

The CPU 26 executes a still-image taking process, and requests a memory I/F 40 to execute a recording process. One frame of image data representing a scene at a time point at which placing the focus lens 12 is completed is evacuated by the still-image taking process from the YUV image area 32b to the still-image area 32d. The memory I/F 40 reads out, through the memory control circuit 30, the image data thus evacuated and writes the read-out image data into the block-continuous-shooting group file. It is noted that, when the lens position indicated by the detected lens position information is coincident with a current position of the focus lens 12, the still-image taking process and the recording process are omitted.

Thereafter, the CPU 26 requests the memory I/F 40 to update a file header. The memory I/F 40 describes block coordinates defining the lens position information detected from the strict AF distance table TBLstr in a header of the block-continuous-shooting group file, corresponding to a frame number of the latest image data written in the block-continuous-shooting group file.

The block-continuous-shooting group file has a structure shown in FIG. 17 at a time point at which a header describing process for number of times equivalent to the total number of the divided blocks (=256 times).

When a reproducing mode is selected by the mode selector switch 28md and a normal reproducing mode is selected by the mode selecting button 28sl, the CPU 26 designates the latest image file recorded in the recording medium 42 and commands the memory I/F 40 and the LCD driver 36 to execute a reproducing process in which a designated image file is noticed.

The memory I/F 40 reads out image data of the designated image file from the recording medium 42, and writes the read-out image data into the still-image area 32b of the SDRAM 32 through the memory control circuit 30. The LCD driver 36 reads out the image data accommodated in the still-image area 32b through the memory control circuit 30 and drives the LCD monitor 38 based on the read-out image data. As a result, a reproduced image based on the image data of the designated image file is displayed on the LCD monitor 38.

When a forwarding operation is performed by a forward button 28fw, the CPU 26 designates a succeeding image file. The designated image file is subjected to the reproducing process similar to that described above, and as a result, the reproduced image is updated.

When a group file reproducing mode is selected by a mode switching operation by the mode selecting button 28sl, the CPU 26 designates the latest group file recorded in the recording medium 42, sets the variable K to “0”, and commands the memory I/F 40 and the LCD driver 36 to reproduce the K-th frame of image data contained in the designated group file. The memory I/F 40 and the LCD driver 36 executes the processes similar to that described above, and as a result, an image based on the K-th frame of the image data (K=0: image data corresponding to the pan-focus setting) is displayed on the LCD monitor 38.

When a group file changing operation is performed by a file changing button 28ch, the CPU 26 designates another group file and sets the variable K to “0”. The designated group file is subjected to the reproducing process similar to that described above, and as a result, an image based on the zero-th frame of image data accommodated in this group file is displayed on the LCD monitor 38.

When the forwarding operation is performed by the forward button 28fw, the variable K is incremented by the CPU 26. However, when the incremented variable K exceeds the number of the frames contained in designated group file, the variable K is set to “0”. The above-described reproducing process is executed corresponding to the variable K, and as a result, the image displayed on the LCD monitor 38 is updated.

When a touch operation to the monitor screen is sensed by a touch sensor 48 in a state where the image data contained in the face-continuous-shooting group file is reproduced, the CPU 26 determines whether or not a touch position is equivalent to any one of one or at least two face images appeared in the reproduced image. Upon determining, the header of the face-continuous-shooting group file created as shown in FIG. 9 is referred to. When the touch position is equivalent to any one of the face images, a frame number of image data focused on the touched face image is detected with reference to the header, and the detected frame number is set to the variable K. In contrary, when the touch position is equivalent to an image different from the face image, the variable K is set to “0”. The reproducing process is executed after the variable K is thus updated.

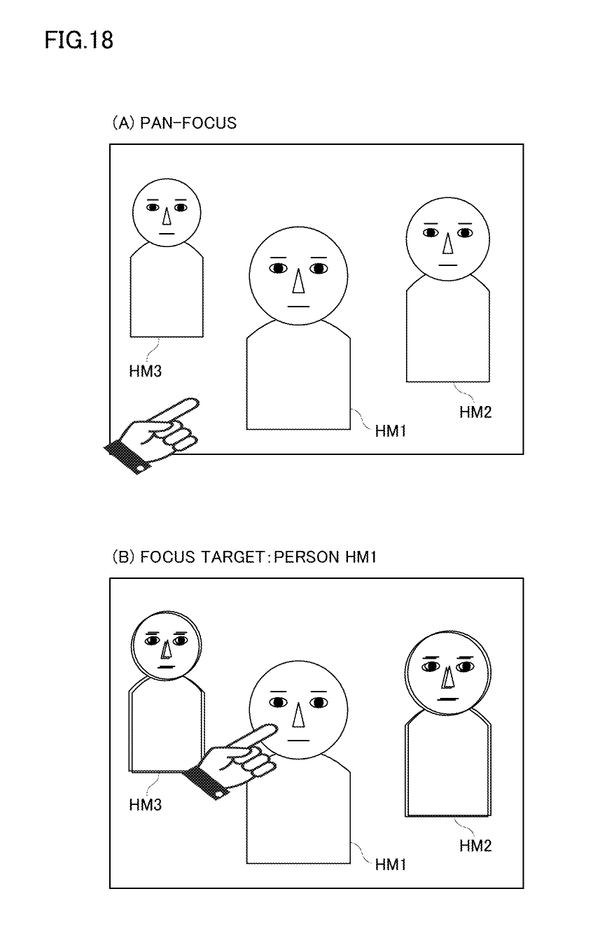

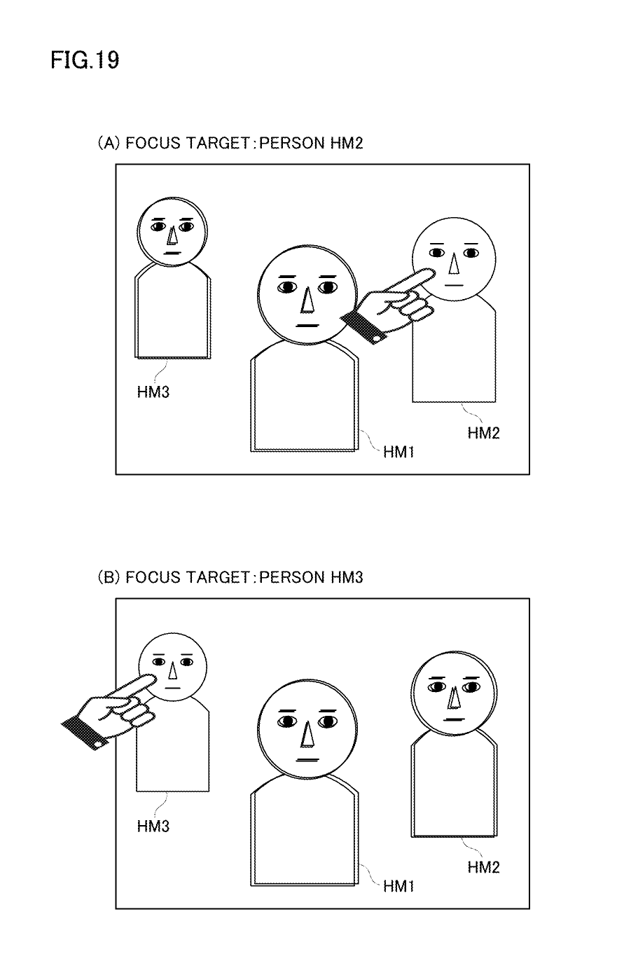

Thus, when the touched image is different from the face image, the reproduced image is updated to an image corresponding to the pan-focus setting (see FIG. 18(A)). In contrary, when the touched image is the face image, the reproduced image is updated to an image focused on the touched face image (see FIG. 18(B), FIG. 19(A) and FIG. 19(B)).

When a touch operation to the monitor screen is sensed by the touch sensor 48 in a state where the image data contained in the block-continuous-shooting group file is reproduced, the CPU 26 detects block coordinates of a touched position, and searches for a frame number corresponding to the detected block coordinates from the header of the block-continuous-shooting group file created as shown in FIG. 17. The variable K is set to the frame number discovered by the searching process, and the reproducing process is executed corresponding to the variable K thus updated.

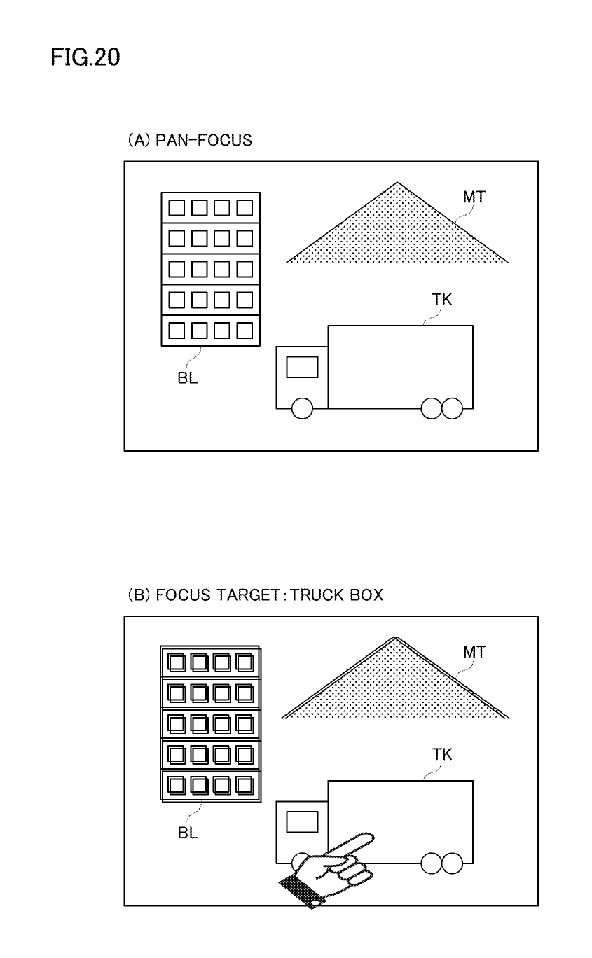

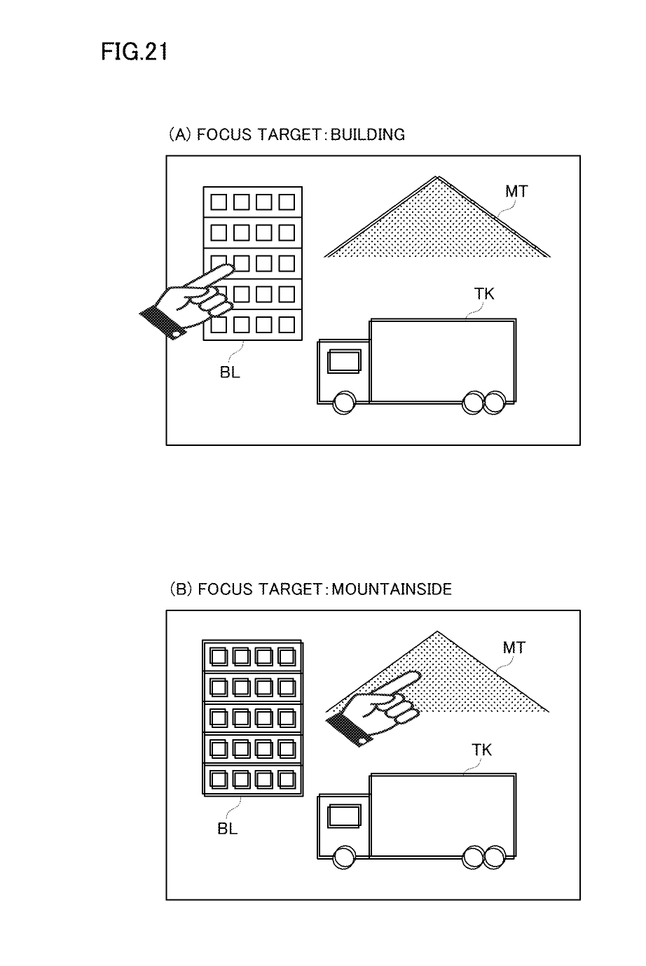

Thus, initially when the block-continuous-shooting group file is designated, an image corresponding to the pan-focus setting is reproduced (see FIG. 20(A)). When the touch operation is performed on the monitor screen, the reproduced image is updated to an image focused on the touched object (see FIG. 20(B), FIG. 21(A) and FIG. 21(B)).

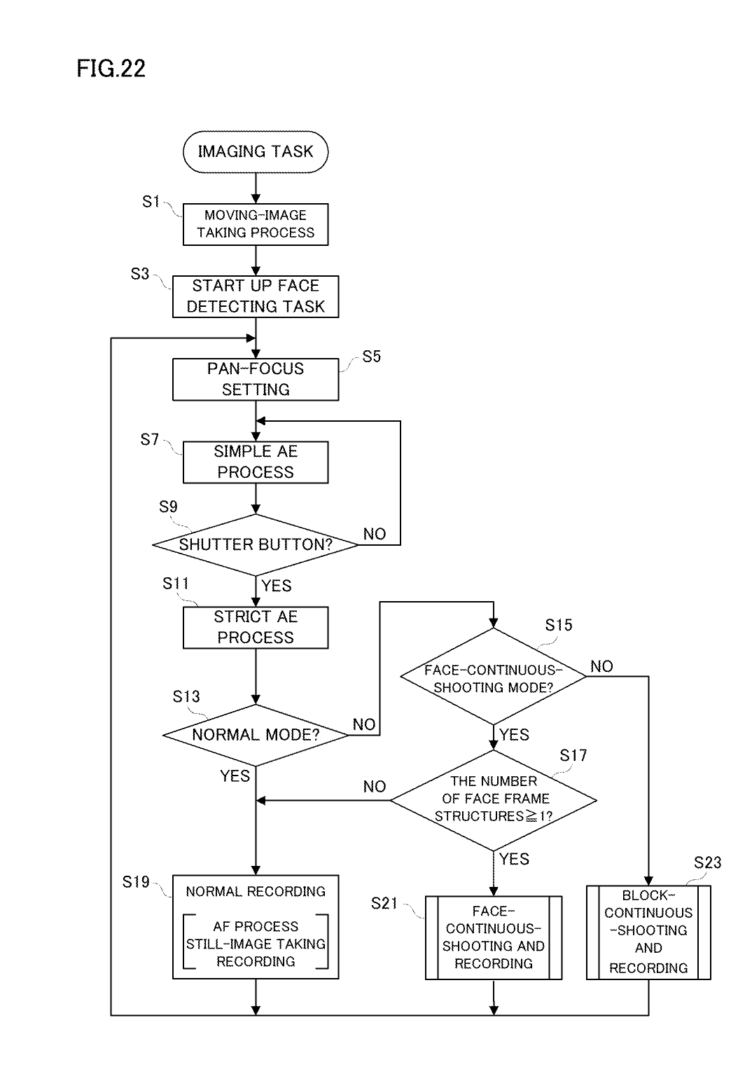

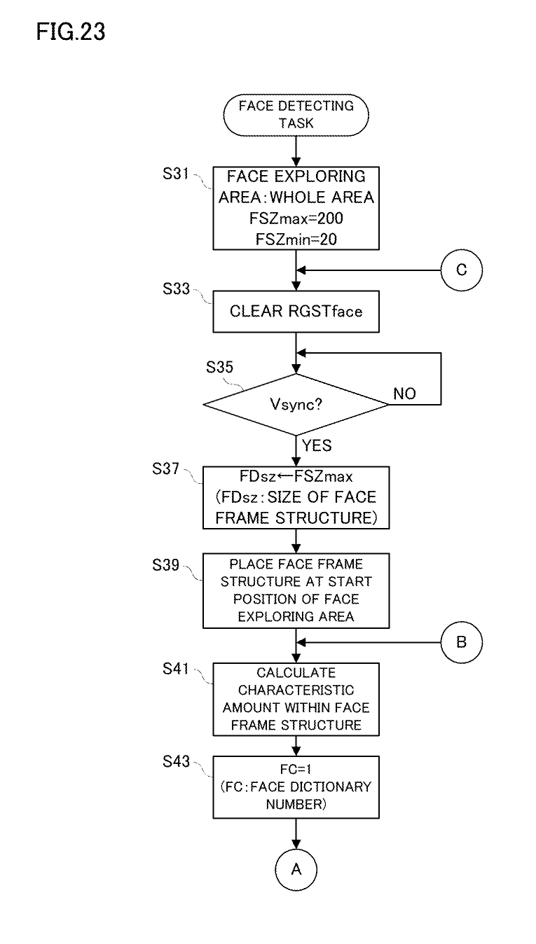

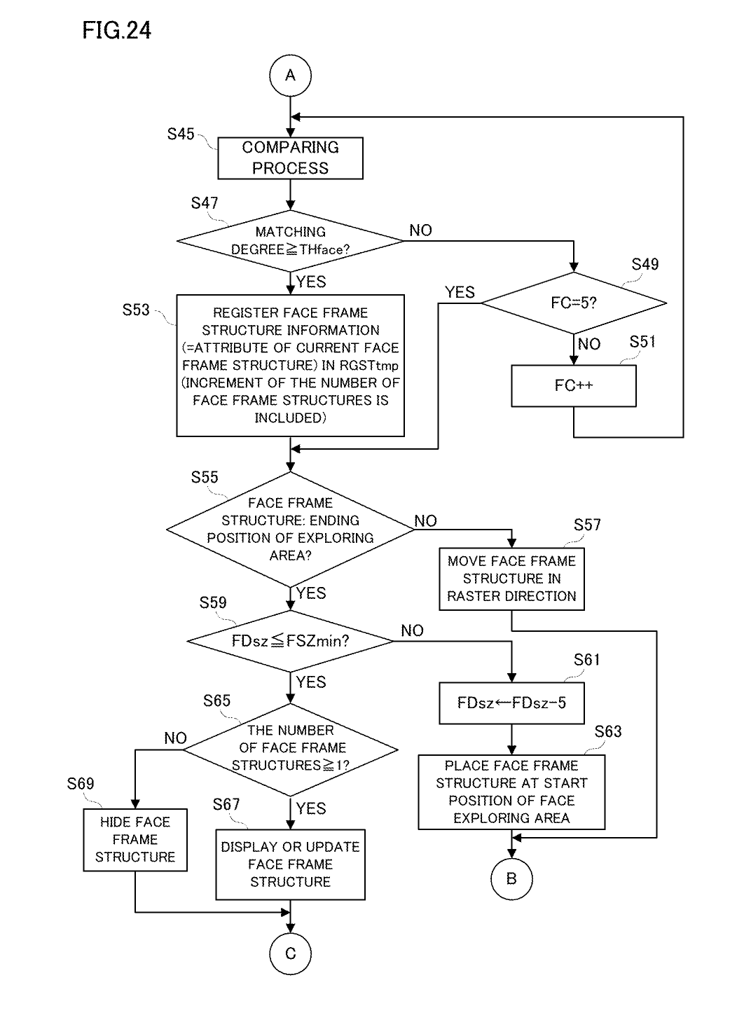

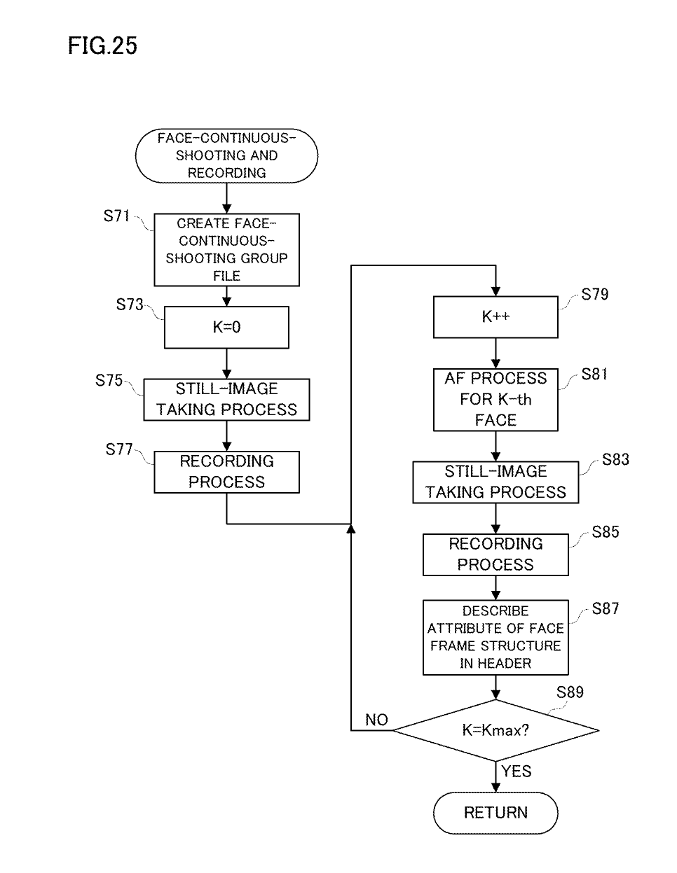

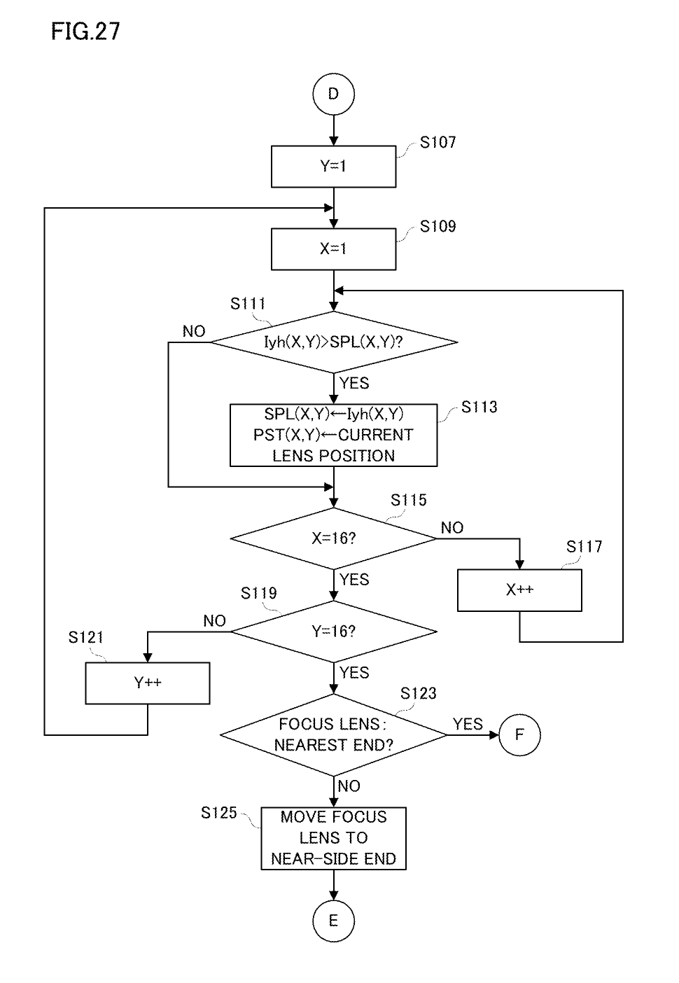

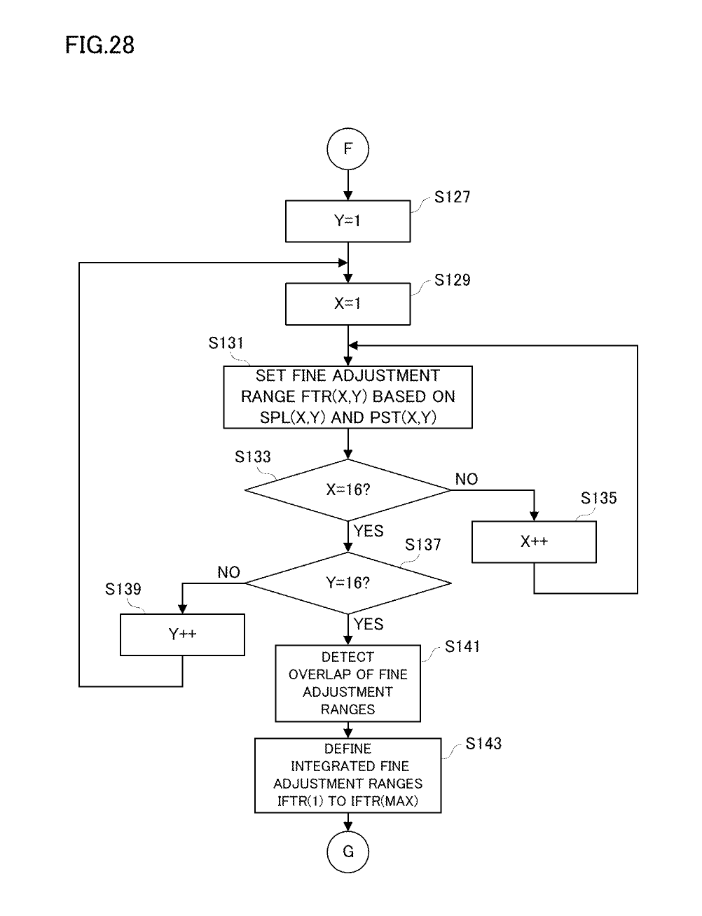

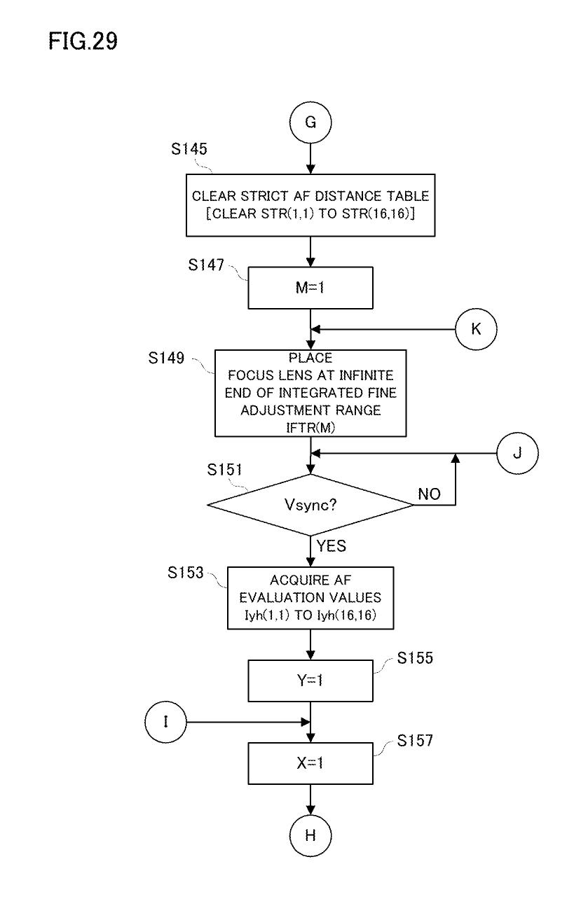

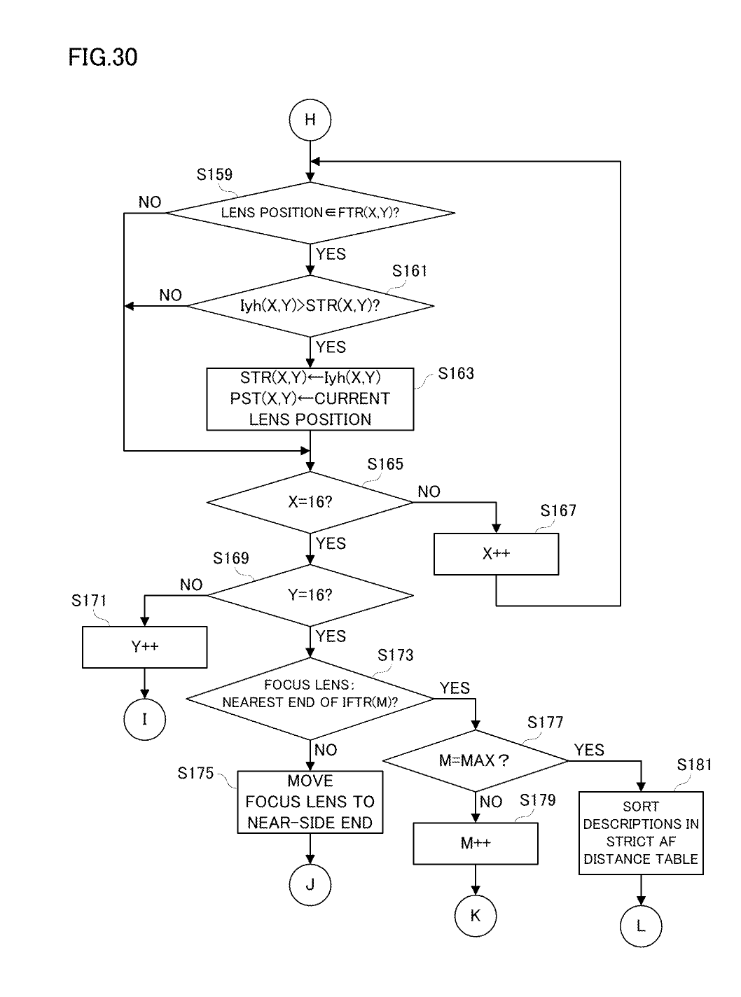

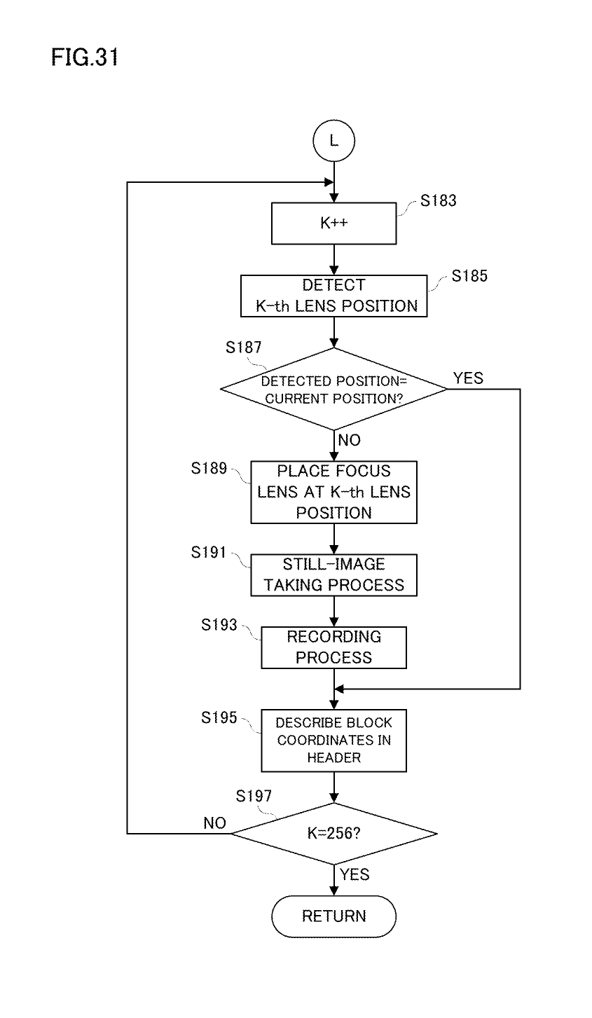

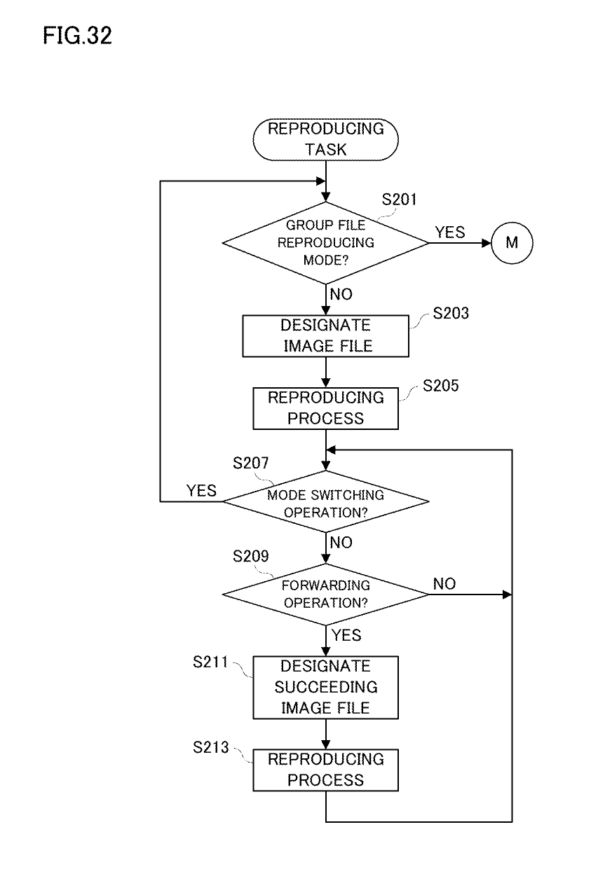

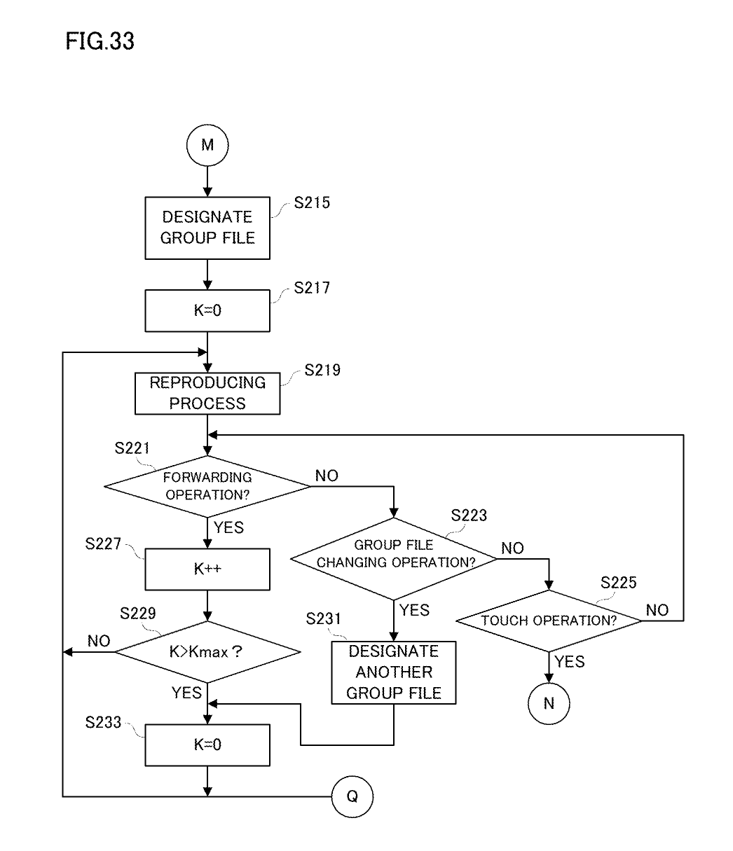

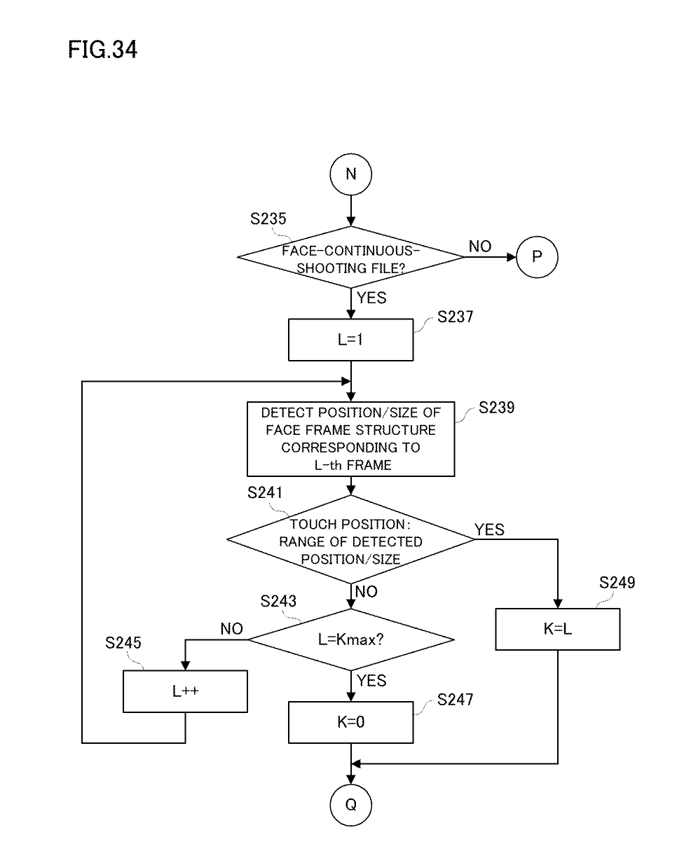

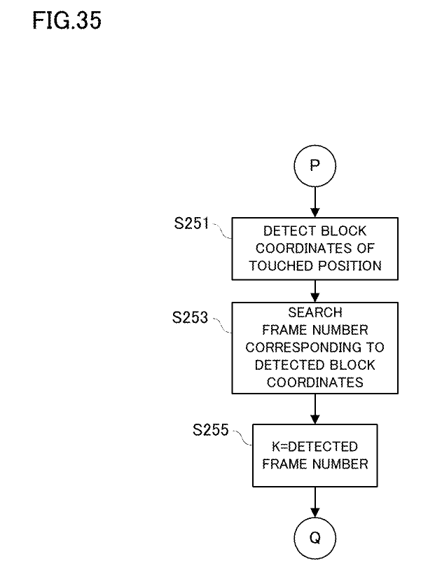

When the imaging mode is selected, the CPU 26 executes a plurality of tasks including the imaging task shown in FIG. 22, FIG. 25 to FIG. 31 and the face detecting task shown in FIG. 23 to FIG. 24, and executes a plurality of tasks including the reproducing task shown in FIG. 32 to FIG. 35 when the reproducing mode is selected. Any of the tasks is executed under a multi task operating system in a parallel manner. It is noted that, control programs corresponding to these tasks are stored in the flash memory 44.

With reference to FIG. 22, in a step S1, the moving-image taking process is started. As a result, a live view image representing the scene is displayed on the LCD monitor 38. In a step S3, the face detecting task is started up, and in a step S5, the pan-focus setting is enabled. In a step S7, the simple AE process is executed. As a result of the pan-focus setting being enabled, a position of the focus lens 12 and an aperture amount of the aperture unit 14 are adjusted so that a depth of field becomes deep. Moreover, the simple AE process is executed with reference to partial AE evaluation values outputted from the AE evaluating circuit 22 corresponding to a center of the evaluation are EVA, and as a result, a brightness of the live view image is adjusted approximately.

In a step S9, it is determined whether or not the shutter button 28sh is operated, and when a determined result is NO, the simple AE process is repeated in the step S7 whereas when the determined result is YES, in a step S11, the strict AE process is executed.

When a face image is detected by the face detecting task, the strict AE process is executed with reference to partial AE evaluation values outputted from the AE evaluating circuit 22 corresponding to the face image. In contrary, when the face image is not detected by the face detecting task, the strict AE process is executed with reference to partial AE evaluation values outputted from the AE evaluating circuit 22 corresponding to the center of the evaluation are EVA. As a result, a brightness of the live view image is adjusted to an optimal value.

In steps S13 and S15, it is determined whether or not the imaging mode at a current time point is any one of a normal mode, a face-continuous-shooting mode and a block-continuous-shooting mode. Moreover, when the imaging mode at a current time point is the face-continuous-shooting mode, in a step S17, it is determined whether or not the number of the face images detected by the face detecting task (=the number of the face frame structures described in the register RGSTface) is equal to or more than “1”.

If the imaging mode at a current time point is the normal mode, or if the number of the detected face images is “0” despite that the imaging mode at a current time point is the face-continuous-shooting mode, in a step S19, the normal recording process (specifically, the AF process, the still-image taking process and the recording process) is executed. When the imaging mode at a current time point is the face-continuous-shooting mode and the number of the face images detected by the face detecting task is equal to or more than “1”, the face-continuous-shooting and recording process is executed in a step S21. Moreover, when the imaging mode at a current time point is the block-continuous-shooting mode, the block-continuous-shooting and recording process is executed in a step S23. Upon completion of the process in the step S19, S21 or S23, the process returns to the step S5.

With reference to FIG. 23, in a step S31, the whole evaluation area EVA is set as the face exploring area. Furthermore, in the step S31, in order to define a variable range of the size of the face frame structure FD, the maximum size FSZmax is set to “200”, and the minimum size FSZmin is set to “20”. In a step S33, the register RGSTface is cleared, and in a step S35, it is determined whether or not the vertical synchronization signal Vsync has been generated. When a determined result is updated from NO to YES, in a step S37, the size of the face frame structure FD is set to “FSZmax”.

In a step S39, the face frame structure FD is placed at the start position (the upper left position) of the face exploring area. In a step S41, partial exploration image data belonging to the face frame structure FD is read out from the exploration image area 32c so as to calculate a characteristic amount of the read-out exploration image data. In a step S43, a face dictionary number FC is set to “1”.

In a step S45, the characteristic amount calculated in the step S41 is compared with a characteristic amount of a dictionary image corresponding to the face dictionary image FC out of the five dictionary images contained in the face dictionary DC_F. In a step S47, it is determined whether or not a matching degree which is a compared result is equal to or more than THface, and in a step S49, it is determined whether or not the face dictionary number FC is “5”.

When a determined result of the step S47 is YES, the process advances to a step S53 so as to resister a position and a size of the face frame structure FD at a current time point, a value of the face dictionary number FC, and a matching degree in the register RGSTface. Also in the step S53, the number of the faces described in the register RGSTface is incremented. Upon completion of the process in the step S53, the process advances to a step S55.

When a determined result of the step S49 is NO, in a step S51, the face dictionary number FC is incremented, and thereafter, the process returns to the step S45. When the determined result of the step S47 is NO and the determined result of the step S49 is YES, the process directly advances to the step S55.

In the step S55, it is determined whether or not the face frame structure FD has reached the ending position (the lower right position) of the face exploring area. When a determined result is NO, in a step S57, the face frame structure FD is moved by a predetermined amount in a raster direction, and thereafter, the process returns to the step S41. When the determined result is YES, in a step S59, it is determined whether or not a size of the face frame structure FD is equal to or less than “FSZmin”. When a determined result is NO, in a step S61, the size of the face frame structure FD is reduced by a scale of “5”, and in a step S63, the face frame structure FD is placed at the start position of the face exploring area. Thereafter, the process returns to the step S41.

When the determined result of the step S59 is YES, in a step S65, it is determined whether or not the number of the face frame structures described in the register RGSTface is equal to or more than “1”. When a determined result is YES, in a step S67, the face-frame-structure display command is applied to the character generator 46 whereas when the determined result is NO, in a step S69, the face-frame-structure hiding command is applied to the character generator 46. As a result of the process in the step S67, a face frame structure character is displayed on the LCD monitor 38 corresponding to a position surrounding the face image. Moreover, as a result of the process in the step S69, displaying the face-frame-structure character is cancelled. Upon completion of the process in the step S67 or S69, the process returns to the step S33.

With reference to FIG. 25, in a step S71, the memory I/F 40 is requested to create the face-continuous-shooting group file, and in a step S73, the variable K is set to “0”. As a result of the process in the step S71, the face-continuous-shooting group file is created in the recording medium 42 by the memory I/F 40. In a step S75, the still-image taking process is executed, and in a step S77, the memory I/F 40 is requested to execute the recording process. The latest one frame of the image data is evacuated by the process in the step S75, from the YUV image area 32b to the still-image area 32d. The memory I/F 40 reads out, through the memory control circuit 30, the image data thus evacuated so as to write the read-out image data into the face-continuous-shooting group file.

In a step S79, the variable K is incremented, and in a step S81, the AF process for Kth face is executed. A focal point is searched with reference to partial AF evaluation values outputted from the AF evaluating circuit 24 corresponding to a K-th face frame structure registered in the register RGSTface, and the focus lens 12 is placed at the focal point discovered thereby.

In a step S83, the still-image taking process is executed, and in a step S85, the memory I/F 40 is requested to execute the recording process. One frame of image data representing a scene at a time point at which the AF process for Kth face is completed is evacuated by the process in the step S83, from the YUV image area 32b to the still-image area 32d. The memory I/F 40 reads out, through the memory control circuit 30, the image data thus evacuated so as to write the read-out image data into the face-continuous-shooting group file.

In a step S87, the memory I/F 40 is requested to update the file header. The memory I/F 40 describes a position and a size of the K-th face frame structure registered in the register RGSTface in the header of the face-continuous-shooting group file, corresponding to a frame number (=K) of the latest image data written in the face-continuous-shooting group file. In a step S89, it is determined whether or not the variable K has reached the maximum value Kmax (=the number of the face frame structures described in the register RGSTface), and when a determined result is NO, the process returns to the step S79 whereas when the determined result is YES, the process returns to a routine in an upper hierarchy.

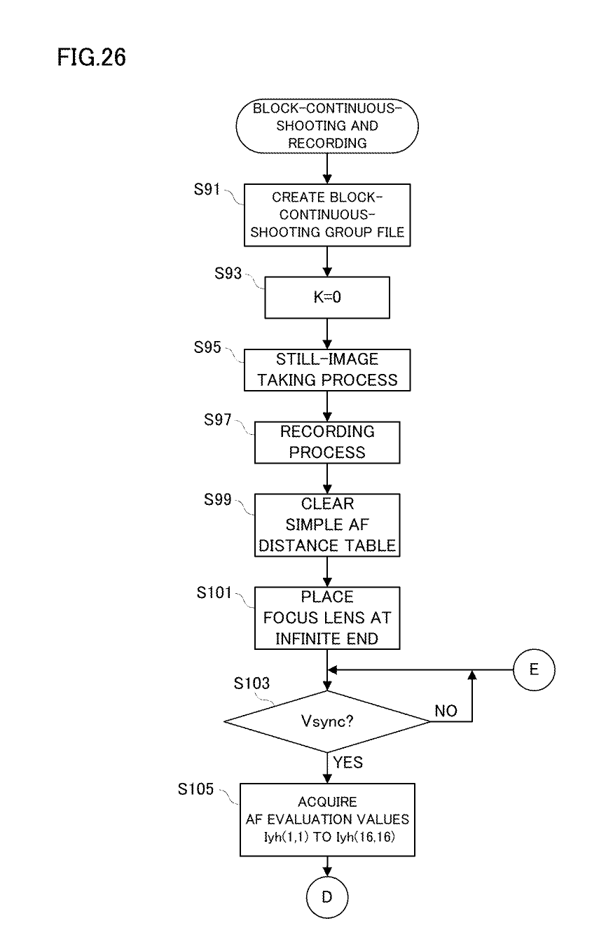

With reference to FIG. 26, in a step S91, the memory I/F 40 is requested to create the block-continuous-shooting group file, and in a step S93, the variable K is set to “0”. As a result of the process in the step S91, the block-continuous-shooting group file is created in the recording medium 42. In a step S95, the still-image taking process is executed, and in a step S97, the memory I/F 40 is requested to execute the recording process. The latest one frame of the image data is evacuated by the process in the step S95, from the YUV image area 32b to the still-image area 32d. The memory I/F 40 reads out, through the memory control circuit 30, the image data thus evacuated so as to write the read-out image data into the block-continuous-shooting group file.

In a step S99, the descriptions of the simple AF distance table TBLspl are cleared, and in a step S101, the focus lens 12 is placed at the infinite end. As a result of the process in the step S99, any of the registered AF evaluation values SPL (1, 1) to SPL (16, 16) described in the simple AF distance table TBLspl indicates “0”, and any of the lens position information PST (1, 1) to PST (16, 16) described in the simple AF distance table TBLspl indicates “indeterminate”. In a step 103, it is determined whether or not the vertical synchronization signal Vsync is generated, and when a determined result is updated from NO to YES, the AF evaluation values Iyh (1, 1) to Iyh (16, 16) outputted from the AF evaluating circuit 24 are taken in a step S105.

In a step S107, the variable Y is set to “1”, and in a step S109, the variable X is set to “1”. In a step S111, it is determined whether or not the AF evaluation value Iyh (X, Y) exceeds the registered AF evaluation value SPL (X, Y), and when a determined result is NO, the process directly advances to a step S115 whereas when the determined result is YES, the process advances to the step S115 via a process in a step S113. In the step S113, the AF evaluation value Iyh (X, Y) is described in the simple AF distance table TBLspl as the registered AF evaluation value SPL (X, Y), and a position of the focus lens 12 at a current time point is described in the simple AF distance table TBLspl as the lens position information PST (X, Y).

In the step S115, it is determined whether or not the variable X has reached “16”, and in a step S119, it is determined whether or not the variable Y has reached “16”. When a determined result of the step S115 is NO, the variable X is incremented in a step S117, and thereafter, the process returns to the step S111. When a determined result of the step S119 is NO, the variable Y is incremented in a step S121, and thereafter, the process returns to the step S109.

When both of the determined result of the step S115 and the determined of the step S119 are YES, in a step S123, it is determined whether or not the focus lens 12 has reached the nearest end. When a determined result is NO, in a step S125, the focus lens 12 is moved by a predetermined amount to the near-side, and thereafter, the process returns to the step S103.

When the determined result is YES, in a step S127, the variable Y is set to “1”, and in a step S129, the variable X is set to “1”. In a step S131, the fine adjustment range FTR (X, Y) is defined based on the registered AF evaluation value SPL (X, Y) and the lens position information PST (X, Y), and the defined fine adjustment range FTR (X, Y) is registered in the simple AF distance table TBLspl. The defined fine adjustment range FTR (X, Y) has expansion enlarged corresponding to an increase of the registered AF evaluation value SPL (X, Y), by using a position defined by the lens position information PST (X, Y) as the center.

In the step S133, it is determined whether or not the variable X has reached “16”, and in a step S137, it is determined whether or not the variable Y has reached “16”. When a determined result of the step S133 is NO, the process returns to the step S131 after the variable X is incremented in a step S135, and when a determined result of the step S137 is NO, the process returns to the step S129 after the variable Y is incremented in a step S139.

When both of the determined result of the step S133 and the determined of the step S137 are YES, overlaps between the fine adjustment ranges FTR (1, 1) to FTR (16, 16) are detected in a step S141, and a plurality of fine adjustment ranges in which an overlapping degree exceeds 90% is integrated in a step S143. As a result, MAX (MAX: an integer equal to or less than 256) of integrated fine adjustment ranges IFTR (1) to IFTR (MAX) are redefined. The redefined integrated fine adjustment ranges IFTR (1) to IFTR (MAX) are described in the integrated fine adjustment range table TBLiftr.

In a step S145, the strict AF distance table TBLstr is cleared. As a result, any of the registered AF evaluation values STR (1, 1) to STR (16, 16) described in the strict AF distance table TBLstr indicates “0”, and any of the lens position information PST (1, 1) to PST (16, 16) described in the strict AF distance table TBLstr indicates “indeterminate”.

In a step S147, the variable M is set to “1”, and in a step S149, the focus lens 12 is placed at the infinite end of the integrated fine adjustment range IFTR (M). In a step S151, it is determined whether or not the vertical synchronization signal Vsync is generated, and when a determined result is updated from NO to YES, the AF evaluation values Iyh (1, 1) to Iyh (16, 16) outputted from the AF evaluating circuit 24 are taken in a step S153.

In a step S155, the variable Y is set to “1”, and in a step S157, the variable X is set to “1”. In a step S159, it is determined whether or not a position of the focus lens 12 at a current time point belongs to the fine adjustment range FTR (X, Y), and in a step S161, it is determined whether or not the AF evaluation value Iyh (X, Y) exceeds the registered AF evaluation value STR (X, Y). When at least one of the determination results of the steps S159 and S161 is NO, the process advances to a step S165. When both of the determined results of the steps S159 and S161 are YES, the process advances to a step S165 via a step S163.

In the step S163, the AF evaluation value Iyh (X, Y) is registered in the strict AF distance table TBLstr as the registered AF evaluation value STR (X, Y), and the position of the focus lens 12 at the current time point is registered in the strict AF distance table TBLstr as the lens position information PST (X, Y).

In the step S165, it is determined whether or not the variable X has reached “16”, and in a step S169, it is determined whether or not the variable Y has reached “16”. When a determined result of the step S165 is NO, the variable X is incremented in a step S167, and thereafter, the process returns to the step S159. Moreover, when a determined result of the step S169 is NO, the variable Y is incremented in a step S171, and thereafter, the process returns to the step S157.

When both of the determined result of the step S165 and the determined of the step S169 are YES, in a step S173, it is determined whether or not the focus lens 12 has reached the nearest end of the integrated fine adjustment range IFTR (MAX), and in a step S177, it is determined whether or not the variable M has reached “MAX”. When a determined result of the step S173 is NO, in a step S175, the focus lens 12 is moved by a predetermined amount to the near-side, and thereafter, the process returns to the step S151. When the determined result of the step S173 is YES whereas a determined result of the step S177 is NO, the variable M is incremented in a step S179, and thereafter, the process returns to the step S149.

When both of the determined result of the step S173 and the determined of the step S177 are YES, the process advances to a step S181 so as to sort the lens position information PST (X, Y) described in the strict AF distance table TBLstr in order from infinity. In a step S183, the variable K is incremented, and in a step S185, the lens position information indicating the K-th lens position from the infinity is detected from the sorted strict AF distance table TBLstr. In a step S187, the lens position indicated by the detected lens position information is coincident with a current position of the focus lens 12, and when a determined result is YES, the process directly advances to a step S195 whereas when the determined result is NO, the process advances to the step S195 via processes in steps S189 to S193.

In the step S189, the focus lens 12 is placed at the lens position indicated by the lens position information detected in the step S185. In the step S191, the still-image taking process is executed, and in a step S193, the memory I/F 40 is requested to execute the recording process. One frame of image data representing a scene at a time point at which the process in the step S189 is completed is evacuated by the process in the step S191 from the YUV image area 32b to the still-image area 32d. The memory I/F 40 reads out, through the memory control circuit 30, the image data thus evacuated so as to write the read-out image data into the block-continuous-shooting group file.

In a step S195, the memory I/F 40 is requested to update the file header. The memory I/F 40 describes the block coordinates defining the lens position information detected in the step S185 in the header of the block-continuous-shooting group file, corresponding to a frame number of the latest image data written in the block-continuous-shooting group file. In a step S197, it is determined whether or not the variable K has reached “256”, and when a determined result is NO, the process returns to the step S183 whereas when the determined result is YES, the process returns to the routine in an upper hierarchy.

With reference to FIG. 32, in a step S201, it is determined whether or not the reproducing mode at a current time point is any of the normal reproducing mode and the group file reproducing mode, and the process advances to a step S203 corresponding to the normal reproducing mode whereas advances to a step S215 corresponding to the group file reproducing mode.

In the step S203, the latest image file is designated, and in a step S205, the memory I/F 40 and the LCD driver 36 are commanded to execute the reproducing process in which a designated image file is noticed. As a result, a reproduced image is displayed on the LCD monitor 38. In a step S207, it is determined whether or not the mode switching operation is performed by the mode selecting button 28sl, and in a step S209, it is determined whether or not the forwarding operation is performed by the forward button 28fw.

When a determined result of the step S207 is YES, the process returns to the step S201. When a determined result of the step S209 is YES, in a step S211, a succeeding image file is designated, and in a step S213, the reproducing process similar to the step S205 described above is executed. As a result, another reproduced image is displayed on the LCD monitor 38. Upon completion of the reproducing process, the process returns to the step S207.

The latest group file is designated in the step S215, the variable K is set to “0” in a step S217, and in a step S219, the memory I/F 40 and the LCD driver 36 are commanded to reproduce the K-th frame of image data contained in the designated group file. As a result, an image based on the K-th frame of the image data is displayed on the LCD monitor 38.

In a step S221, it is determined whether or not the forwarding operation is performed by the forward button 28fw, in a step S223, it is determined whether or not the group file changing operation is performed by the file changing button 28ch, and in a step S225, it is determined whether or not the touch operation to the monitor screen is performed.

When a determined result of the step S221 is YES, in a step S227, the variable K is incremented, and in a step S229, it is determined whether or not the incremented variable K exceeds “Kmax” (the number of the frames contained in designated group file). When a determined result is NO, the process directly returns to the step S219 whereas when the determined result is YES, the process returns to the step S219 after the variable K is set to “0” in a step S233. When a determined result of the step S223 is YES, another group file is designated in a step S231, and the process returns to the step S219 after the variable K is set to “0” in the step S233.

When a determined result of the step S225 is YES, in a step S235, it is determined whether or not the designated group file is any of the face-continuous-shooting file and the block-continuous-shooting file, and the process advances to a step S237 corresponding to the face-continuous-shooting file whereas advances to a step S251 corresponding to the block-continuous-shooting file.

In the step S237, a variable L is set to “1”, and in a step S239, a position and a size of a face frame structure corresponding to an L-th frame are detected with reference to the header of the designated group file. In a step S241, it is determined whether or not a touched position belongs to a range defined according to the detected position and size. When a determined result is YES, in a step S249, the variable K is set to a value of the variable L, and thereafter, the process returns to the step S219. On the other hand, when the determined result is NO, in a step S243, it is determined whether or not the variable L has reached “Kmax”, and when a determined result is NO, the process returns to the step S239 after the variable L is incremented in a step S245 whereas when the determined result is YES, the process returns to the step S219 after the variable K is set to “0” in a step S247.

Thus, when the touched image is the face image, the reproduced image is updated to an image focused on the touched face image. In contrary, when the touched image is different from the face image, the reproduced image is updated to an image corresponding to the pan-focus setting.

In the step S251, the block coordinates of the touched position are detected, and in a step S253, a frame number corresponding to the detected block coordinates is searched from the header of the designated group file. In a step S255, the frame number discovered by the searching process is set to the variable K. Upon completion of the process in the step S255, the process returns to the step S219. Thus, when the touch operation is performed on the monitor screen, the reproduced image is updated to an image focused on the touched object.

As can be seen from the above-described explanation, when the face-continuous-shooting mode (or the block-continuous-shooting mode) is selected under the imaging task, the CPU 26 acquires a plurality of frames of image data including one or at least two frames of image data respectively focused on one or at least two faces (or objects), corresponding to a common viewing field (S75 to S89, S181 to S197). The acquired plurality of frames of image data are recorded on the recording medium 42 as the face-continuous-shooting group file (or the block-continuous-shooting group file). When the face-continuous-shooting group file (or the block-continuous-shooting group file) is designated under the reproducing mode, the CPU 26 reproduces any one of the plurality of frames of image data contained in the designated group file (S219), and accepts the touch operation of designating any one of one or at least two faces (or objects) appeared in the reproduced image (S225). The CPU 26 searches for image data focused on the face (or object) designated by the touch operation from among the plurality of frames of image data contained in the designated group file (S237 to S245, S251 to S253), and updates image data to be reproduced to image data different depending on a searched result (S247 to S249, S255).

Thus, when the touch operation of designating any one of the one or at least two faces (or objects) appeared in the reproduced image is accepted, image data focused on the designated face (or object) is searched from among the plurality of frames of image data. The reproduced image and the plurality of frames of image data to be a searching target have a mutually common viewing field, and the reproduced image is updated to the image different depending on a result of a searching process. Thereby, an operability of an image reproducing is improved.

It is noted that, in this embodiment, when a face image appeared in the image reproduced from the face-continuous-shooting group file is touched, or when an object appeared in the image reproduced from the block-continuous-shooting group file is touched, the reproduced image is immediately updated. However, a character surrounding the touched face image or object image may be temporarily displayed so as to update the reproduced image thereafter. In this case, a position and a size of the character is defined based on the position and size of the face frame structure described in the header of the face-continuous-shooting group file or the block coordinates described in the header of the block-continuous-shooting group file.

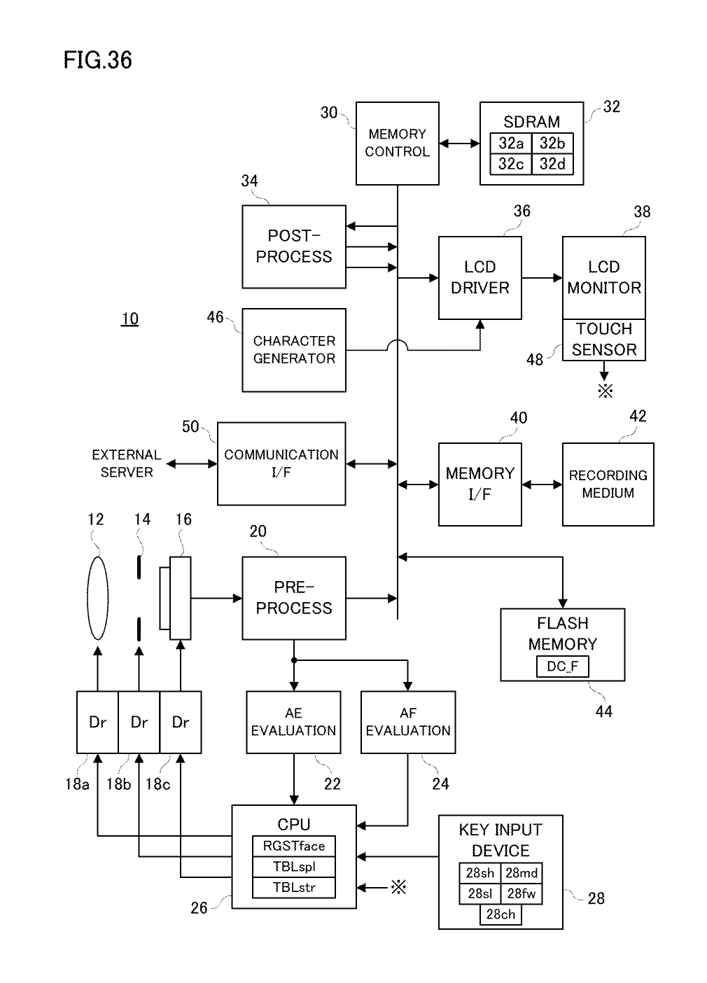

Moreover, in this embodiment, the control programs equivalent to the multi task operating system and the plurality of tasks executed thereby are previously stored in the flash memory 44. However, a communication I/F 50 may be arranged in the digital camera 10 as shown in FIG. 36 so as to initially prepare a part of the control programs in the flash memory 44 as an internal control program whereas acquire another part of the control programs from an external server as an external control program. In this case, the above-described procedures are realized in cooperation with the internal control program and the external control program.

Moreover, in this embodiment, the processes executed by the CPU 26 are divided into a plurality of tasks as described above. However, these tasks may be further divided into a plurality of small tasks, and furthermore, a part of the divided plurality of small tasks may be integrated into the main task. Moreover, when each of tasks is divided into the plurality of small tasks, the whole task or a part of the task may be acquired from the external server.

Moreover, in this embodiment, the digital camera is assumed, however, the present invention may be applied to a digital photo frame or a viewer which reproduces image data recorded in a recording medium. In this case, a plurality of frames of image data which corresponds to a common viewing field and includes one or at least two frames of image data respectively focused on one or at least two faces (or objects) are acquired from the recording medium installed at the digital photo frame or the viewer.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image reproducing control apparatus, comprising:
an acquirer which acquires a plurality of images including one or at least two images respectively focused on one or at least two objects, corresponding to a common viewing field;
a reproducer which reproduces any one of the plurality of images acquired by said acquirer;
an acceptor which accepts a designating operation of designating any one of one or at least two objects appeared in the image reproduced by said reproducer;
a searcher which searches for an image focused on the object designated by the designating operation from among the plurality of images acquired by said acquirer; and
an updater which updates an image to be reproduced by said reproducer to an image different depending on a searched result of said searcher.

2. An image reproducing control apparatus according to claim 1, wherein said acquirer includes a creator which creates management information indicating a corresponding relationship between the one or at least two objects and the one or at least two images, and said searcher executes a searching process with reference to the management information created by said creator.

3. An image reproducing control apparatus according to claim 1, wherein the plurality of images acquired by said acquirer includes a reference image corresponding to a pan-focus setting, and said updater includes a reference image designator which designates the reference image as an updated image when the searched result of said searcher is equivalent to a non-detection.

4. An image reproducing control apparatus according to claim 1, further comprising:
an imager which repeatedly outputs an image; and
an explorer which explores an object noticed by said acquirer, based on the image outputted from said imager.

5. An image reproducing control apparatus according to claim 4, wherein the object noticed by said acquirer has a predetermined characteristic pattern, and said explorer includes a partial image explorer which explores for a partial image having the predetermined characteristic pattern on the image outputted from said imager.

6. An image reproducing control apparatus according to claim 4, wherein said explorer includes an extractor which extracts a high-frequency component of the image outputted from said imager, a changer which changes a focal length in parallel with an extracting process of said extractor, and a detector which detects a focal length in which the high-frequency component extracted by said extractor reaches a maximum.

7. An image reproducing control apparatus according to claim 1, further comprising a displayer which displays on a screen the image reproduced by said reproducer, wherein the designating operation is equivalent to a touch operation to said screen.

8. An image reproducing control apparatus according to claim 1, wherein said acquirer acquires the plurality of images in response to a single acquiring operation.

9. An image reproducing control program recorded on a non-transitory recording medium when executed by a processor of an image reproducing control apparatus, the program causing the image reproducing control apparatus to perform the steps comprising:
an acquiring step of acquiring a plurality of images including one or at least two images respectively focused on one or at least two objects, corresponding to a common viewing field;
a reproducing step of reproducing any one of the plurality of images acquired by said acquiring step;
an accepting step of accepting a designating operation of designating any one of one or at least two objects appeared in the image reproduced by said reproducing step;
a searching step of searching for an image focused on the object designated by the designating operation from among the plurality of images acquired by said acquiring step; and
an updating step of updating an image to be reproduced by said reproducing step to an image different depending on a searched result of said searching step.

10. An image reproducing control method executed by an image reproducing control apparatus, comprising:
an acquiring step of acquiring a plurality of images including one or at least two images respectively focused on one or at least two objects, corresponding to a common viewing field;
a reproducing step of reproducing any one of the plurality of images acquired by said acquiring step;
an accepting step of accepting a designating operation of designating any one of one or at least two objects appeared in the image reproduced by said reproducing step;
a searching step of searching for an image focused on the object designated by the designating operation from among the plurality of images acquired by said acquiring step; and
an updating step of updating an image to be reproduced by said reproducing step to an image different depending on a searched result of said searching step.
